(19) United States
(12) Patent Application Publication
(10) Pub. No.: US 2022/0413144 A1
(43) Pub. Date: Dec. 29, 2022

(54) SIGNAL PROCESSING DEVICE, SIGNAL PROCESSING METHOD, AND DISTANCE MEASUREMENT DEVICE

(71) Applicant: SONY GROUP CORPORATION, Tokyo (JP)

(72) Inventors: Hajime MIHARA, Tokyo (JP); Shun KAIZU, Kanagawa (JP)

(73) Assignee: SONY GROUP CORPORATION, Tokyo (JP)

(21) Appl. No.: 17/779,026

(22) PCT Filed: Dec. 4, 2020
(86) PCT No.: PCT/JP2020/045171

§ 371 Date: May 23, 2022

(30) Foreign Application Priority Data
Dec. 18, 2019 (JP) 2019-227917

(51) Int. Cl. G01S 17/36; G01S 17/894

(52) U.S. Cl. CPC G01S 17/36; G01S 17/894

(57) ABSTRACT

The present technology relates to a signal processing device, a signal processing method, and a distance measurement device capable of preventing erroneous detection of the number of cycles N in a method of resolving ambiguity of the number of cycles N on the basis of a result of distance measurement using two frequencies.

A signal processing device (33) includes: a condition determination unit (43) that determines whether or not a condition [Expression (27) or Expression (28)] that neither carrying nor borrowing occurs is satisfied in a number-of-cycles determination expression for determining the number of cycles of 2π of either a first phase difference or a second phase difference, the first phase difference being detected by a distance measurement sensor (2) when irradiation light is emitted at a first frequency (fₗ), the second phase difference being detected by the distance measurement sensor when the irradiation light is emitted at a second frequency (fₕ) higher than the first frequency; and a distance calculation unit (46) that determines the number of cycles of 2π from the number-of-cycles determination expression in a case where it is determined that the condition is satisfied and calculates a distance from an object by using the first phase difference and the second phase difference. The present technology is applicable to, for example, a distance measurement device that measures a distance from a subject, or other devices.

### TECHNICAL FIELD

The present technology relates to a signal processing device, a signal processing method, and a distance measurement device, and more particularly to a signal processing device, a signal processing method, and a distance measurement device capable of preventing erroneous detection of the number of cycles N in a method of resolving ambiguity of the number of cycles N on the basis of a result of distance measurement at two frequencies.

### BACKGROUND ART

In recent years, as the semiconductor technology has advanced, a distance measurement module for measuring a distance from an object has decreased in size. This makes it possible to mount the distance measurement module on, for example, a mobile terminal that is a small information processing device having a communication function, such as a so-called smartphone.

For example, an Indirect Time of Flight (ToF) method is known as a distance measurement method of the distance measurement module. The Indirect ToF method is a method of detecting reflected light obtained by emitting irradiation light toward an object and receiving the irradiation light reflected by a surface of the object, detecting a time from the emission of the irradiation light to the reception of the reflected light as a phase difference, and calculating a distance from the object on the basis of the phase difference.

In the distance measurement by the Indirect ToF method, there is ambiguity because the number of cycles N is unknown. That is, the detected phase difference is repeated at a cycle of 2π, and thus a plurality of distances can correspond to one phase difference. In other words, it is unknown how many times (N times) the detected phase difference has repeated the cycle of 2π.

For the ambiguity of the number of cycles N, for example, Patent Document 1 discloses a method of using luminance information to determine that, for example, the phase difference is in the first cycle in a case where the luminance is high and the phase difference is in the second or subsequent cycles in a case where the luminance is low.

Further, Non-Patent Document 1 discloses a method of assuming spatial continuity of an image, detecting an edge serving as a change of a cycle, and setting a cycle so as to smoothly connect the detected edge.

Further, Non-Patent Document 2 discloses a method of resolving the ambiguity of the number of cycles N by analyzing a depth image obtained by performing driving at a first frequency fₗ and a depth image obtained by performing driving at a second frequency fₕ (fₗ<fₕ).

### CITATION LIST

### Patent Document

Patent Document 1: Japanese Patent Application Laid-Open No. 2015-501927

### Non-Patent Document

Non-Patent Document 1: Resolving depth measurement ambiguity with commercially available range imaging cameras, in Proceedings of SPIE, 2010
Non-Patent Document 2: Analysis of Errors in ToF Range Imaging With Dual-Frequency Modulation, IEEE Transactions on Instrumentation and Measurement, 2011

### SUMMARY OF THE INVENTION

### Problems to be Solved by the Invention

In the technology of Non-Patent Document 2, the number of cycles N is estimated by the remainder theorem, but the estimated cycle changes in a case where an error of a certain value or more occurs in a detected phase difference due to noise or the like. As a result, a large error of several meters occurs in the final distance measurement result.

The present technology has been made in view of such a circumstance, and an object thereof is to prevent erroneous detection of the number of cycles N in a method of resolving the ambiguity of the number of cycles N on the basis of a result of distance measurement at two frequencies.

### Solutions to Problems

A signal processing device according to a first aspect of the present technology includes: a condition determination unit that determines whether or not a condition that neither carrying nor borrowing occurs is satisfied in a number-of-cycles determination expression for determining the number of cycles of 2π of either a first phase difference or a second phase difference, the first phase difference being detected by a distance measurement sensor when irradiation light is emitted at a first frequency, the second phase difference being detected by the distance measurement sensor when the irradiation light is emitted at a second frequency higher than the first frequency; and a distance calculation unit that determines the number of cycles of 2π from the number-of-cycles determination expression in a case where it is determined that the condition is satisfied and calculates a distance from an object by using the first phase difference and the second phase difference.

In a signal processing method according to a second aspect of the present technology, a signal processing device determines whether or not a condition that neither carrying nor borrowing occurs is satisfied in a number-of-cycles determination expression for determining the number of cycles of 2π of either a first phase difference or a second phase difference, the first phase difference being detected by a distance measurement sensor when irradiation light is emitted at a first frequency, the second phase difference being detected by the distance measurement sensor when the irradiation light is emitted at a second frequency higher than the first frequency, and determines the number of cycles of 2π from the number-of-cycles determination expression in a case where it is determined that the condition is satisfied and calculates a distance from an object by using the first phase difference and the second phase difference.

A distance measurement device according to a third aspect of the present technology includes: a distance measurement sensor that detects a first phase difference when irradiation light is emitted at a first frequency and detects a second phase difference when the irradiation light is emitted at a second frequency higher than the first frequency; and a signal processing device that calculates a distance from an object by using the first phase difference or the second phase difference, in which the signal processing device includes a condition determination unit that determines whether or not a condition that neither carrying nor borrowing occurs is satisfied in a number-of-cycles determination expression for determining the number of cycles of 2π of either the first phase difference or the second phase difference, and a distance calculation unit that determines the number of cycles of 2π from the number-of-cycles determination expression in a case where it is determined that the condition is satisfied and calculates the distance from the object by using the first phase difference and the second phase difference.

In the first to third aspects of the present technology, it is determined whether or not a condition that neither carrying nor borrowing occurs is satisfied in a number-of-cycles determination expression for determining the number of cycles of 2π of either a first phase difference or a second phase difference, the first phase difference being detected by a distance measurement sensor when irradiation light is emitted at a first frequency, the second phase difference being detected by the distance measurement sensor when the irradiation light is emitted at a second frequency higher than the first frequency, and the number of cycles of 2π is determined from the number-of-cycles determination expression in a case where it is determined that the condition is satisfied, and then a distance from an object is calculated by using the first phase difference and the second phase difference.

The signal processing device and the distance measurement device may be independent devices or may be modules incorporated in other devices.

### BRIEF DESCRIPTION OF DRAWINGS

FIG. 1 illustrates a distance measurement principle of an Indirect ToF method.

FIG. 2 illustrates a distance measurement principle of the Indirect ToF method.

FIG. 3 is an explanatory diagram of the method disclosed in Non-Patent Document 2.

FIG. 4 is an explanatory diagram of the method disclosed in Non-Patent Document 2.

FIG. 5 is an explanatory diagram of the method disclosed in Non-Patent Document 2.

FIG. 6 is an explanatory diagram of the method disclosed in Non-Patent Document 2.

FIG. 7 is an explanatory diagram of a problem in the method disclosed in Non-Patent Document 2.

FIG. 8 is a block diagram showing a schematic configuration example of a distance measurement system to which a method of the present disclosure is applied.

FIG. 9 is a block diagram showing a detailed configuration example of a signal processing unit of a distance measurement device.

FIG. 10 is a flowchart showing first distance measurement processing by the distance measurement system of FIG. 8.

FIG. 11 is a flowchart showing second distance measurement processing by the distance measurement system of FIG. 8.

FIG. 12 is a perspective view illustrating a configuration example of a chip of a distance measurement device.

FIG. 13 is a block diagram showing a configuration example of an electronic device to which the present technology is applied.

FIG. 14 is a block diagram showing a configuration example of an embodiment of a computer to which the present technology is applied.

FIG. 15 is a block diagram showing an example of a schematic configuration of a vehicle control system.

FIG. 16 is an explanatory diagram showing an example of installation positions of a vehicle outside information detection unit and an imaging unit.

### MODE FOR CARRYING OUT THE INVENTION

Hereinafter, modes for carrying out the present technology (hereinafter, referred to as “embodiments”) will be described with reference to the accompanying drawings. Note that, in this specification and the drawings, components having substantially the same functional configurations will be represented as the same reference signs, and repeated description thereof will be omitted. Description will be provided in the following order.

1. Principle of distance measurement by Indirect ToF method

2. Method disclosed in Non-Patent Document 2

3. Method of present disclosure

4. Schematic configuration example of distance measurement system

5. Detailed configuration example of signal processing unit

6. Processing flow of first distance measurement processing

7. Processing flow of second distance measurement processing

8. Application to three or more frequencies

9. Application example of application

10. Configuration example of chip of distance measurement device

11. Configuration example of electronic device

12. Configuration example of computer

13. Examples of application to moving objects

<1. Principle of Distance Measurement by Indirect ToF Method>

The present disclosure relates to a distance measurement module that performs measurement by the Indirect ToF method.

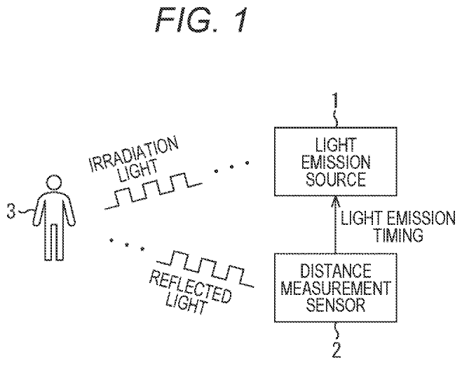

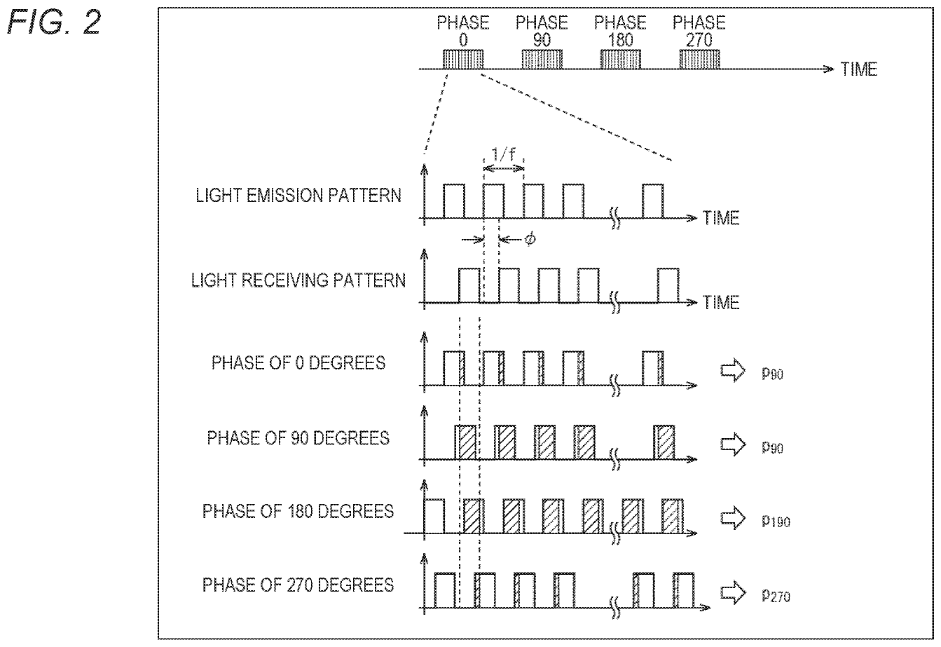

Therefore, first, a distance measurement principle of the Indirect ToF method will be briefly described with reference to FIGS. 1 and 2.

As illustrated in FIG. 1, a light emission source 1 emits light modulated at a predetermined frequency (e.g., 100 MHz or the like) as irradiation light. The irradiation light is, for example, infrared light having a wavelength within a range of about 850 nm to 940 nm. A light emission timing at which the light emission source 1 emits the irradiation light is issued as an instruction from a distance measurement sensor 2.

The irradiation light emitted from the light emission source 1 is reflected by a surface of a predetermined object 3 serving as a subject, becomes reflected light, and enters the distance measurement sensor 2. The distance measurement sensor 2 detects the reflected light, detects a time from the emission of the irradiation light to the reception of the reflected light as a phase difference, and calculates a distance from the object on the basis of the phase difference.

A depth value d corresponding to the distance from the distance measurement sensor 2 to the predetermined object 3 serving as the subject can be calculated from Expression (1) below.

$$\begin{matrix}[ Math . 1 ] & \\ d = \frac{1}{2} \cdot c \cdot Δ t & ( 1 )\end{matrix}$$

In Expression (1), Δt represents a time until the irradiation light emitted from the light emission source 1 is reflected by the object 3 and enters the distance measurement sensor 2, and c represents a speed of light.

The irradiation light emitted from the light emission source 1 is pulsed light having a light emission pattern that is repeatedly turned on and off at a predetermined modulation frequency f at a high speed, such as light illustrated in FIG. 2. One cycle T of the light emission pattern is 1/f. In the distance measurement sensor 2, a phase of the reflected light (light receiving pattern) is detected while being shifted in accordance with the time Δt until the light arrives at the distance measurement sensor 2 from the light emission source 1. When an amount of phase shift (phase difference) between the light emission pattern and the light receiving pattern is represented as φ, the time Δt can be calculated from Expression (2) below.

$$\begin{matrix}[ Math . 2 ] & \\ Δ t = \frac{1}{f} \cdot \frac{ϕ}{2 π} & ( 2 )\end{matrix}$$

Therefore, the depth value d from the distance measurement sensor 2 to the object 3 can be calculated from Expression (3) below on the basis of Expressions (1) and (2).

$$\begin{matrix}[ Math . 3 ] & \\ d = \frac{c ϕ}{4 π f} & ( 3 )\end{matrix}$$

Next, a method of calculating the above-described phase difference φ will be described.

Each pixel of a pixel array formed in the distance measurement sensor 2 repeats on/off at a high speed and accumulates charges only during an on period.

The distance measurement sensor 2 sequentially switches on/off execution timings of the respective pixels of the pixel array, accumulates charges at each execution timing, and outputs detection signals according to the accumulated charges.

There are four kinds of on/off execution timings, for example, a phase of 0 degrees, a phase of 90 degrees, a phase of 180 degrees, and a phase of 270 degrees.

The execution timing in the phase of 0 degrees is a timing at which an on timing (light receiving timing) of each pixel of the pixel array is set to a phase of the pulsed light emitted from the light emission source 1, that is, the same phase as that of the light emission pattern.

The execution timing in the phase of 90 degrees is a timing at which the on timing (light receiving timing) of each pixel of the pixel array is delayed by 90 degrees from the pulsed light (light emission pattern) emitted from the light emission source 1.

The execution timing in the phase of 180 degrees is a timing at which the on timing (light receiving timing) of each pixel of the pixel array is delayed by 180 degrees from the pulsed light (light emission pattern) emitted from the light emission source 1.

The execution timing in the phase of 270 degrees is a timing at which the on timing (light receiving timing) of each pixel of the pixel array is delayed by 270 degrees from the pulsed light (light emission pattern) emitted from the light emission source 1.

For example, the distance measurement sensor 2 sequentially switches the light receiving timing in the following order: the phase of 0 degrees, the phase of 90 degrees, the phase of 180 degrees, and the phase of 270 degrees, and acquires a luminance value (accumulated charges) of the reflected light at each light receiving timing. In FIG. 2, a timing at which the reflected light is incident at the light receiving timing (on timing) of each phase is shaded.

As illustrated in FIG. 2, when the light receiving timing is set to the phase of 0 degrees, the phase of 90 degrees, the phase of 180 degrees, and the phase of 270 degrees and the luminance values (accumulated charges) thereof are set to p₀, p₉₀, p₁₈₀, and p₂₇₀, respectively, the phase difference φ can be calculated from Expression (4) below by using the luminance values p₀, p₉₀, p₁₈₀, and p₂₇₀.

$$\begin{matrix}[ Math . 4 ] & \\ ∅ = arctan \frac{{p}_{90} - {p}_{270}}{{p}_{0} - {p}_{180}} = arctan ( \frac{Q}{I} ) & ( 4 )\end{matrix}$$

I=p₀−p₁₈₀ and Q=p₉₀−p₂₇₀ in Expression (4) represent a real part I and an imaginary part Q into which a phase of a modulated wave of the irradiation light is converted on a complex plane (IQ plane). By inputting the phase difference φ calculated by Expression (4) to Expression (3) above, the depth value d from the distance measurement sensor 2 to the object 3 can be calculated.

Further, intensity of light received by each pixel is referred to as confidence conf and can be calculated from Expression (5) below. This confidence conf corresponds to an amplitude A of the modulated wave of the irradiation light.

[Math. 5]

A=conf=\sqrt{I²+Q²} (5)

Further, a magnitude B of ambient light included in the received reflected light can be estimated by Expression (6) below.

[Math. 6]

B=(p₀+p₉₀+p₁₈₀+p₂₇₀)−\sqrt{(p₀−p₁₈₀)²+(p₉₀−p₂₇₀)²} (6)

In a case where the distance measurement sensor 2 includes one charge accumulation unit in each pixel of the pixel array like a general image sensor, the distance measurement sensor 2 switches the light receiving timing in each frame in the following order: the phase of 0 degrees, the phase of 90 degrees, the phase of 180 degrees, and the phase of 270 degrees, and generates detection signals corresponding to the accumulated charges (the luminance value p₀, the luminance value p₉₀, the luminance value p₁₈₀, and the luminance value p₂₇₀) in the respective phases as described above. This requires detection signals for four frames.

Meanwhile, in a case where the distance measurement sensor 2 includes two charge accumulation units in each pixel of the pixel array, the distance measurement sensor 2 can alternately accumulate charges in the two charge accumulation units and therefore acquire detection signals of two light receiving timings having inverted phases, such as, for example, the phase of 0 degrees and the phase of 180 degrees, in one frame. In this case, only detection signals for two frames are required to acquire detection signals in four phases, i.e., the phase of 0 degrees, the phase of 90 degrees, the phase of 180 degrees, and the phase of 270 degrees.

The distance measurement sensor 2 calculates the depth value d that is a distance from the distance measurement sensor 2 to the object 3 on the basis of a detection signal supplied from each pixel of the pixel array. Then, a depth map in which the depth value d is stored as a pixel value of each pixel and a confidence map in which the confidence conf is stored as the pixel value of each pixel are generated and output from the distance measurement sensor 2 to the outside.

<2. Method Disclosed in Non-Patent Document 2>

As described above, the time from the emission of the irradiation light to the reception of the reflected light is detected as the phase difference φ in the distance measurement by the Indirect ToF method. Because the phase difference φ periodically repeats 0≤φ<2π in accordance with the distance, it is unknown how many times (N times) the number of cycles N of 2π, that is, the detected phase difference has repeated the cycle of 2π. This state in which how many times (N times) the phase difference φ has repeated the cycle is unknown will be referred to as the ambiguity of the number of cycles N.

Non-Patent Document 2 described above discloses a method of resolving the ambiguity of the number of cycles N by analyzing a depth map obtained by setting a modulation frequency of the light emission source 1 to the first frequency fₗ and a depth map obtained by setting the modulation frequency of the light emission source 1 to the second frequency fₕ (fₗ<fₕ).

Here, the method of resolving the ambiguity of the number of cycles N disclosed in Non-Patent Document 2 will be described on the assumption that the distance measurement sensor 2 is a sensor for executing the method disclosed in Non-Patent Document 2.

There will be described an example where the first frequency fₗ of the light emission source 1 is 60 MHz and the second frequency fₕ (fₗ<fₕ) is 100 MHz. Hereinafter, in order to facilitate understanding, the first frequency fₗ=60 MHz will also be referred to as a low frequency fₗ, and the second frequency fₕ=100 MHz will also be referred to as a high frequency fₕ.

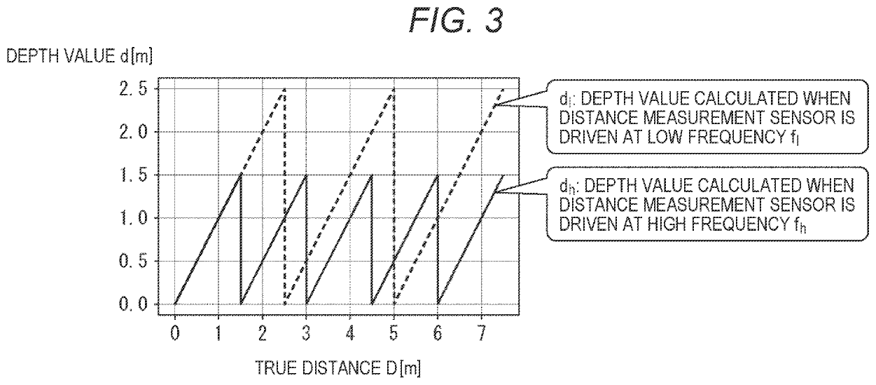

FIG. 3 shows the depth values d calculated from Expression (3) in the distance measurement sensor 2 in a case where the modulation frequency of the light emission source 1 is set to the low frequency fₗ=60 MHz and is set to the high frequency fₕ=100 MHz.

In FIG. 3, the horizontal axis represents an actual distance D from the object (hereinafter, referred to as a true distance D), and the vertical axis represents the depth value d calculated from the phase difference φ detected by the distance measurement sensor 2.

As shown in FIG. 3, in a case where the modulation frequency is the low frequency fₗ=60 MHz, one cycle is 2.5 m, and the depth value d is repeated within a range of 0 m to 2.5 m as the true distance D increases. Meanwhile, in a case where the modulation frequency is the high frequency fₕ=100 MHz, one cycle is 1.5 m, and the depth value d is repeated within a range of 0 m to 1.5 m as the true distance D increases.

The true distance D and the depth value d establish a relationship in Expression (7) below.

D=d+N·d^{max}(N=0,1,2,3, . . . ) (7)

Here, d^{max} represents a maximum value that the depth value d can take, and dₗ^{max}=2.5 is established when the low frequency is fₗ=60 MHz, whereas dₕ^{max}=1.5 is established when the high frequency is fₕ=100 MHz. N corresponds to the number of cycles indicating how many times the phase difference has repeated 2π.

The relationship between the true distance D and the depth value d in Expression (7) shows the ambiguity of the number of cycles N.

The distance measurement sensor 2 normalizes the depth values with a ratio of two frequencies such that both the maximum value dₗ^{max}=2.5 of the depth value di obtained when the low frequency is fₗ=60 MHz and the maximum value dₕ^{max}=1.5 of the depth value dₕ obtained when the high frequency is fₕ=100 MHz become integers.

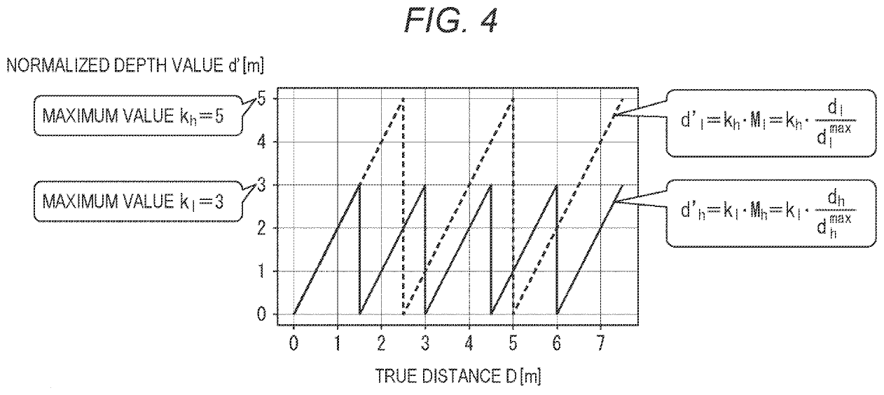

FIG. 4 shows a relationship between the true distance D and the normalized depth values d′ obtained when the low frequency is fₗ=60 MHz and the high frequency is fₕ=100 MHz.

A normalized depth value dₗ′ at the low frequency fₗ=60 MHz can be expressed as kₕ·Mₗ, a normalized depth value dₕ′ at the high frequency fₕ=100 MHz can be expressed as kₗ·Mₕ, and kₕ and kₗ are expressed as Expressions (8) below and correspond to the maximum values of the normalized depth values d′.

$$\begin{matrix}[ Math . 7 ] & \\ {k}_{h} = \frac{{f}_{h}}{gc d ( {f}_{h} , {f}_{l} )} = \frac{100 [ MHz ]}{20 [ MHz ]} = 5 \\ {k}_{l} = \frac{{f}_{l}}{gc d ( {f}_{h} , {f}_{l} )} = \frac{60 [ MHz ]}{20 [ MHz ]} = 3 & ( 8 )\end{matrix}$$

Here, gcd(fₕ, fₗ) is a function for calculating the greatest common divisor of fₕ and fₗ. Further, Mₗ and Mₕ are expressed as Expressions (9) by using the depth value dₗ at the low frequency fₗ, the maximum value dₗ^{max} thereof, the depth value dₕ at the high frequency fₕ, and the maximum value dₕ^{max} thereof.

$$\begin{matrix}[ Math . 8 ] & \\ {M}_{l} = \frac{{d}_{l}}{{d}_{l}^{max}} , \\ {M}_{h} = \frac{{d}_{h}}{{d}_{h}^{max}} & ( 9 )\end{matrix}$$

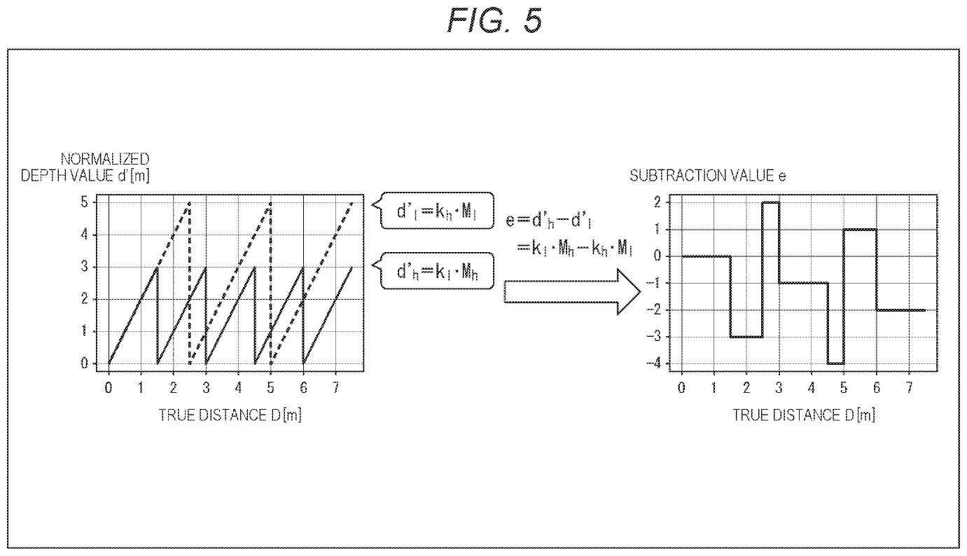

Next, as shown in FIG. 5, the distance measurement sensor 2 calculates a value e={kₗ·Mₕ−kₕ·Mₗ} obtained by subtracting the normalized depth value dₗ′=kₙ·Mₗ at the low frequency fₗ from the normalized depth value dₕ′=kₗ−Mₕ at the high frequency fₕ.

As can be seen from the subtraction value e shown on the right side of FIG. 5, a relationship between the normalized depth value dₕ′ at the high frequency fₕ and the normalized depth value dₗ′ at the low frequency fₗ is uniquely determined within a section of the true distance D. For example, a distance at which the subtraction value e is −3 is only in a section of the true distance D from 1.5 m to 2.5 m, and a distance at which the subtraction value e is 2 is only in a section of the true distance D from 2.5 m to 3.0 m.

Next, the distance measurement sensor 2 determines k₀ that satisfies Expression (10) below and calculates the number of cycles Nₗ from Expression (11). In Expressions (10) and (11), % represents an operator for extracting a remainder. For example, k₀ is 2 when the low frequency is fₗ=60 MHz and the high frequency is fₕ=100 MHz.

$$\begin{matrix}[ Math . 9 ] & \\ {k}_{0} {M}_{h} \% {M}_{l} = l & ( 10 )\end{matrix}$$

$${N}_{l} = {k}_{0} ( {k}_{l} \cdot {M}_{h} - {k}_{h} \cdot {M}_{l} ) \% {k}_{l} = {k}_{0} ( {k}_{l} \cdot \frac{{d}_{h}}{{d}_{h}^{max}} - {k}_{h} \cdot \frac{{d}_{l}}{{d}_{l}^{max}} ) \% {k}_{l} \qquad ( 11 )$$

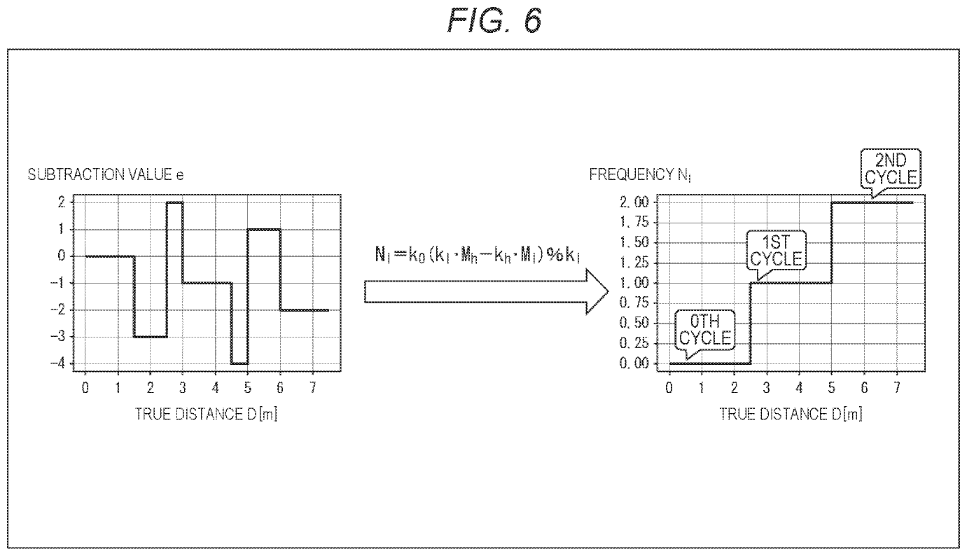

FIG. 6 shows a result of calculating the number of cycles Nₗ from Expression (11).

As can be seen from FIG. 6, the number of cycles Nₗ calculated from Expression (11) represents the number of cycles in a phase space. Expression (11) is also referred to as a number-of-cycles determination expression for determining the number of cycles Nₗ of 2π.

In the method disclosed in Non-Patent Document 2, the number of cycles Nₗ is calculated as described above to resolve the ambiguity of the number of cycles N, and the final depth value d is determined.

Note that, in a case where the subtraction value e in FIG. 5 is calculated from e={kₕ·Mₗ−kₗ·Mₕ}, that is, by subtracting the normalized depth value dₕ′=kₗ·Mₕ at the high frequency fₕ from the normalized depth value dₗ′=kₕ·Mₗ at the low frequency fₗ, the number of cycles N is calculated as the number of cycles Nₕ from Expression (11)′ below based on the high frequency fₕ, instead of the number of cycles Nₗ from Expression (11) based on the low frequency fₗ.

$$\begin{matrix}[ Math . 10 ] & \\ {k}_{0} {M}_{1} \% {M}_{h} = 1 , & ( 10 )\end{matrix}$$

$${N}_{h} = {k}_{0} ( {k}_{h} \cdot {M}_{1} - {k}_{1} \cdot {M}_{h} ) \% {k}_{h} = {k}_{0} ( {k}_{h} \cdot \frac{{d}_{1}}{{d}_{1}^{max}} - {k}_{l} \cdot \frac{{d}_{h}}{{d}_{h}^{max}} ) \% {k}_{h} , \qquad ( 11 )$$

Meanwhile, some noise is actually generated in an observation value obtained by the distance measurement sensor 2.

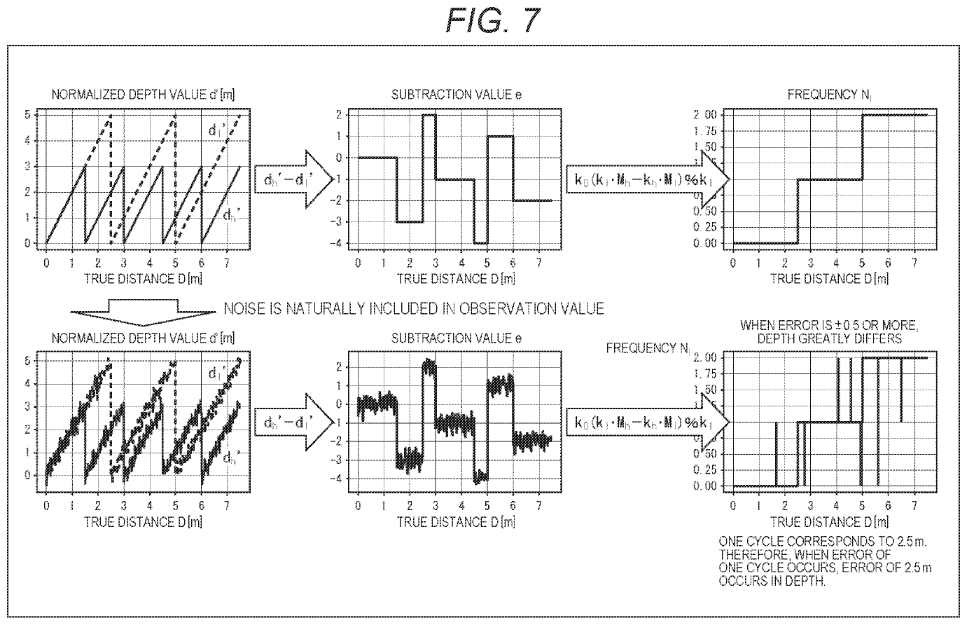

FIG. 7 shows an example of the normalized depth values d′, the subtraction value e, and the number of cycles Nₗ obtained in a case where noise is included in the observation value obtained by the distance measurement sensor 2.

An upper part of FIG. 7 shows theoretical calculation values described with reference to FIGS. 3 to 6, and a lower part of FIG. 7 shows calculation values obtained in a case where noise is included in the observation value obtained by the distance measurement sensor 2.

The number of cycles Nₗ is determined by a remainder obtained by dividing k₀(kₗ·Mₕ−kₕ·Mₗ) by kₗ. However, when an error of ±0.5 or more is included in the portion k₀(kₗ·Mₕ−kₕ·Mₗ) divided by kₗ due to noise, carrying or borrowing occurs as in the example of the number of cycles Nₗ in the lower part of FIG. 7, and an error for one cycle occurs in the number of cycles Nₗ. One cycle at the low frequency fₗ=60 MHz is 2.5 m, and thus, when an error of one cycle occurs, an error of 2.5 m occurs.

<3. Method of Present Disclosure>

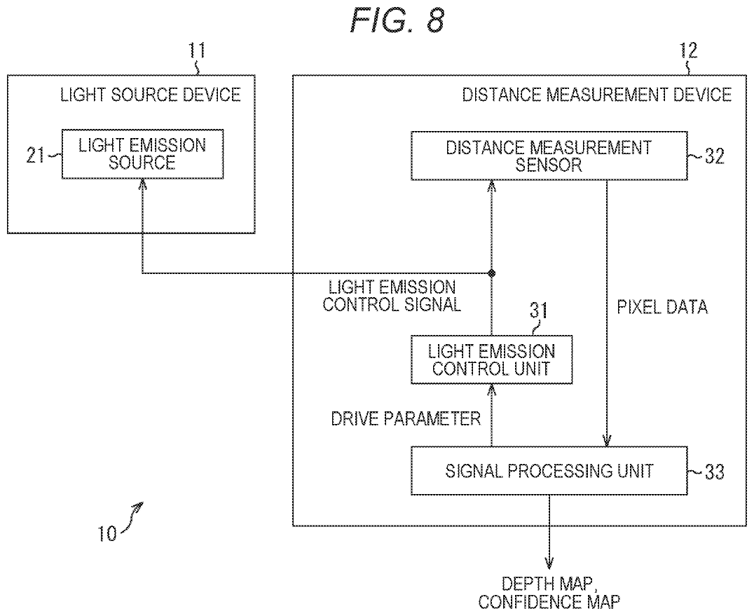

In view of this, a distance measurement device 12 described later with reference to FIG. 8 performs control such that neither carrying nor borrowing occurs due to noise, in other words, an error of ±0.5 or more is not included in the portion k₀(kₗ·Mₕ−kₕ·Mₗ) divided by kₗ in the number-of-cycles determination expression in Expression (11) above.

Further, conversely, it can also be said that noise can be tolerated as long as neither carrying nor borrowing occurs. Therefore, it is also possible to perform control so as to reduce power consumption as long as neither carrying nor borrowing occurs.

First, a method of the present disclosure executed by the distance measurement device 12 of FIG. 8 will be described.

First, it is assumed that additive noise (light shot noise) expressed as a normal distribution having an average of 0 and a variance of σ²(p) occurs in a luminance value p observed by the distance measurement device 12. The variance σ²(p) can be expressed as Expression (12), and constants c₀ and c₁ are values determined by a drive parameter such as a sensor gain and can be obtained by simple measurement.

σ²(p)=c₀+c₁·p (12)

The additive noise expressed as the normal distribution N(0; σ²(p)) having the average of 0 and the variance of σ²(p) also occurs in the real part I=p₀−p₁₈₀ and the imaginary part Q=p₉₀−p₂₇₀ in Expression (4). When the noise included in the real part I is represented as n_{I} and the noise included in the imaginary part Q is represented as n_{Q}, the real part I and the imaginary part Q considering the noise are formulated as in Expressions (13) and (14).

$$\begin{matrix}I + {n}_{I} = {p}_{0} + N ( 0 ; {σ}^{2} ( {p}_{0} ) ) - {p}_{180} + N ( 0 ; {σ}^{2} ( {p}_{180} ) ) \\ = {p}_{0} + N ( 0 ; {c}_{0} + {c}_{1} \cdot {p}_{0} ) - {p}_{180} + N ( 0 ; {c}_{0} + {c}_{1} \cdot {p}_{180} )\end{matrix} \qquad ( 13 )$$

$$\begin{matrix}Q + {n}_{Q} = {p}_{90} + N ( 0 ; {σ}^{2} ( {p}_{90} ) ) - {p}_{270} + N ( 0 ; {σ}^{2} ( {p}_{270} ) ) \\ = {p}_{90} + N ( 0 ; {c}_{0} + {c}_{1} \cdot {p}_{90} ) - {p}_{270} + N ( 0 ; {c}_{0} + {c}_{1} \cdot {p}_{270} )\end{matrix} \qquad ( 14 )$$

Further, when

N(μ₁;σ₁)−N(μ₂;σ₂)=N(μ₁−μ₂;σ₁+σ₂)

which is a property of the normal distribution, is used,

Expressions (13) and (14) can be expressed as follows.

I+n_{I}=p₀−p₁₈₀+N(0;c₀+c₁(p₀+p₁₈₀)) (13A)

Q+n_{Q}=p₉₀−p₂₇₀+N(0;c₀+c₁(p₉₀+p₂₇₀)) (14A)

That is, the noise n_{I} generated in the real part I can be described as a normal distribution having a variance V[I]=c₀+c₁·(p₀+p₁₈₀), and the noise n_{Q} generated in the imaginary part Q can be described as a normal distribution having a variance V[Q]=c₀+c₁·(p₉₀+p₂₇₀).

Next, the phase difference φ detected by the distance measurement device 12 is expressed as Expression (4), and there will be described conversion of the phase difference φ detected by the distance measurement device 12 into a variance V[φ] based on the variance V[I] of the noise n_{I} generated in the real part I of Expression (13A) and the variance V[Q] of the noise n_{Q} generated in the imaginary part Q of Expression (14A).

First, when there is a random variable X having an average μₓ and a variance σ²ₓ, a variance of arctan(X) will be described. The variance of arctan(X) is obtained as an approximate value up to the first order by the Taylor expansion.

A derivative (arctan (X))′ of arctan(X) is as follows.

$${( arc tan ( X ) )}^{′} = \frac{1}{1 + {X}^{2}} \qquad [ Math . 11 ]$$

Therefore, when arctan(X) is linearly approximated,

$$arc tan ( X ) \approx arc tan ( {μ}_{x} ) + \frac{1}{1 + {μ}_{x}^{2}} X \qquad [ Math . 12 ]$$

is established.

A variance of the random variable X is σ²ₓ, and thus a variance V[arctan(X)] of arctan(X) can be approximated to

$$\begin{matrix}[ Math . 13 ] & \\ V [ arc tan ( X ) ] \approx {( \frac{1}{1 + {μ}_{x}^{2}} )}^{2} {σ}_{x}^{2} & ( 15 )\end{matrix}$$

from V[k·X]=k²·V[X] (k is a constant). Two wavy lines in Expression (15) represent approximation.

Then, the random variable X=Q/I is also obtained as an approximate value up to the first order by the Taylor expansion on the assumption that the real part I is a random variable having the average μ_{I} and the variance σ_{I}² and the imaginary part Q is a random variable having the average μ_{Q} and the variance σ_{Q}².

The Taylor expansion of the random variable X=Q/I described to the first order is expressed as follows.

$$\begin{matrix}\frac{Q}{I} \approx \frac{{μ}_{Q}}{{μ}_{I}} + \frac{\partial ( \frac{Q}{I} )}{\partial I} ( I - {μ}_{I} ) + \frac{\partial ( \frac{Q}{I} )}{\partial Q} ( Q - {μ}_{Q} ) \\ = \frac{{μ}_{Q}}{{μ}_{I}} - \frac{Q}{{I}^{2}} ( I - {μ}_{I} ) + \frac{1}{I} ( Q - {μ}_{Q} )\end{matrix} \qquad [ Math . 14 ]$$

At this time, the variance V[X]=V[Q/I] of the random variable X=Q/I is expressed as follows.

$$\begin{matrix}[ Math . 15 ] & \\ \begin{matrix}V [ X ] = V [ \frac{Q}{I} ] \approx {( - \frac{Q}{{I}^{2}} )}^{2} V [ I ] + {( \frac{1}{I} )}^{2} V [ Q ] \\ = \frac{{Q}^{2}}{{I}^{4}} V [ I ] + \frac{1}{{I}^{2}} V [ Q ] \\ = \frac{{μ}_{Q}^{2}}{{μ}_{I}^{2}} ( \frac{V [ I ]}{{μ}_{I}^{2}} + \frac{V [ Q ]}{{μ}_{Q}^{2}} )\end{matrix} & ( 16 )\end{matrix}$$

A variance to be finally obtained is the variance V[φ]=V[arctan(Q/I)] of the phase difference φ, and thus, when an average μx=μQ/μI of the random variable X=Q/I and the variance V[X]=V[Q/I] of the random variable X=Q/I obtained from Expression (16) are substituted into Expression (15),

$$\begin{matrix}[ Math . 16 ] & \\ V [ ϕ ] = \frac{{μ}_{Q}^{2} V [ I ] + {μ}_{I}^{2} V [ Q ]}{{( {μ}_{I}^{2} + {μ}_{Q}^{2} )}^{2}} & ( 17 )\end{matrix}$$

is obtained. At this time, when the square root √(μ_{I}²+μ_{Q}²) of a sum of squares of the real part I and the imaginary part Q is equal to the amplitude A in Expression (5) and the variances V[I] and V[Q] are approximated to the same variance σ2, the variance V[φ] can be expressed as Expression (18).

$$\begin{matrix}[ Math . 17 ] & \\ V [ ϕ ] = \frac{{σ}^{2}}{{A}^{2}} = \frac{{c}_{0} + {c}_{1} ( A + B )}{{A}^{2}} & ( 18 )\end{matrix}$$

Here, A in Expression (18) represents the amplitude (signal intensity) of the reflected light expressed as Expression (5), and B represents the magnitude of the ambient light expressed as Expression (6).

From the above, in a case where the additive noise expressed as the normal distribution having the average 0 and the variance σ²(p) is assumed to be generated in the luminance value p observed by the distance measurement device 12, the variance V[φ] of the noise n included in the detected phase difference φ can be expressed as Expression (18).

Next, there will be described a noise induced error included in the number of cycles Nₗ calculated from Expression (11) in the method of resolving the ambiguity of the number of cycles N disclosed in Non-Patent Document 2.

As described with reference to FIG. 7, when an error of ±0.5 or more is included in the portion k₀(kₗ·Mₕ−kₕ·Mₗ) divided by kₗ due to noise, carrying or borrowing occurs.

Conversely, in a case where no noise occurs,

k₀(kₗ·Mₕ−kₕ·Mₗ) (19)

which is a part divided by kₗ (hereinafter, also referred to as a kₗ division part)

is always an integer value.

In a case where the noise nₗ of the normal distribution described above is generated in the depth value dₗ detected at the low frequency fₗ and the noise nₕ of the normal distribution described above is generated in the depth value dₕ detected at the high frequency fₕ, the kₗ division part of Expression (19) can be expressed as follows.

$${k}_{0} ( {k}_{1} \cdot ( {M}_{h} + {n}_{h} ) - {k}_{h} \cdot ( {M}_{1} + {n}_{1} ) ) = {k}_{0} ( {k}_{1} \cdot ( \frac{{d}_{h}}{{d}_{h}^{max}} + {n}_{h} ) - {k}_{h} \cdot ( \frac{{d}_{1}}{{d}_{1}^{max}} + {n}_{1} ) ) \qquad [ Math . 18 ]$$

At this time, the noise induced error err can be expressed as follows.

err=k₀(kₗ·nₕ−kₕ·nₗ) (20)

In order to prevent carrying or borrowing in the kₗ division part of Expression (19), the noise induced error err is only required not to include an error of ±0.5 or more. That is, the following is established.

−0.5<err<0.5 (21)

It is assumed that the noise nₗ is generated in accordance with the normal distribution N(0; σ²ₗ) and the noise n h is generated in accordance with the normal distribution N(0; σ²ₕ), and thus an occurrence distribution of the noise induced error err is a normal distribution of the following expression.

err=N(0;k₀²(kₗ²·σ²ₕ+kₕ²·σ²ₗ)) (22)

Therefore, there is a condition that the noise induced error err falls within the range of ±0.5 with a probability of 99.6%. That is, ±3σ of the noise induced error err falls within the range of ±0.5,

3σ[err]<0.5 (23)

is calculated.

Here, σ[err] is obtained from Expression (22).

σ[err]=\sqrt{k₀²(kₗ²σₕ²+kₕ²σₗ²)} [Math. 19]

Therefore, Expression (23) can be expressed as follows.

[Math. 20]

3·\sqrt{k₀²(kₗ²σₕ²+kₕ²σₗ²)}<0.5 (24)

Here, σₕ² and σₗ² are expressed as

$$\begin{matrix}[ Math . 21 ] & \\ {σ}_{h}^{2} = {σ}^{2} ( \frac{{d}_{h}}{{d}_{h}^{max}} ) = {σ}^{2} ( \frac{{ϕ}_{h}}{2 π} ) = \frac{1}{{( 2 π )}^{2}} {σ}^{2} ( {ϕ}_{h} ) \\ {σ}_{1}^{2} = {σ}^{2} ( \frac{{d}_{1}}{{d}_{1}^{max}} ) = {σ}^{2} ( \frac{{ϕ}_{1}}{2 π} ) = \frac{1}{{( 2 π )}^{2}} {σ}^{2} ( {ϕ}_{1} ) & ( 25 )\end{matrix}$$

and

σ²(φₕ) and σ²(φₗ) can be expressed as follows on the basis of Expression (18).

$$\begin{matrix}[ Math . 22 ] & \\ {σ}^{2} ( {ϕ}_{h} ) = \frac{{c}_{0} + {c}_{1} ( {A}_{h} + B )}{{A}_{h}^{2}} \\ {σ}^{2} ( {ϕ}_{1} ) = \frac{{c}_{0} + {c}_{1} ( {A}_{1} + B )}{{A}_{1}^{2}} & ( 26 )\end{matrix}$$

Thus, when Expressions (25) and (26) are substituted into Expression (24),

$$\begin{matrix}[ Math . 23 ] & \\ {k}_{1}^{2} \frac{{c}_{0} + {c}_{1} ( {A}_{h} + B )}{{A}_{h}^{2}} + {k}_{h}^{2} \frac{{c}_{0} + {c}_{1} ( {A}_{1} + B )}{{A}_{1}^{2}} < {( \frac{π}{3 {k}_{0}} )}^{2} & ( 27 )\end{matrix}$$

is established.

Therefore, when the condition of Expression (27) is satisfied, neither carrying nor borrowing occurs in the number of cycles Nₗ calculated from Expression (11) with a probability of 99.6%.

By determining whether or not the condition of Expression (27) is satisfied, the distance measurement device 12 of FIG. 8 can confirm whether or not carrying or borrowing occurs in the number of cycles Nₗ and then calculate a true distance Dₗ=dₗ+Nₗ·dₗ^{max}.

That is, according to the method of the present disclosure, it is possible to prevent erroneous detection of the number of cycles N and calculate the depth value d in the method of resolving the ambiguity of the number of cycles N disclosed in Non-Patent Document 2.

Note that Expression (27) is a conditional expression in which the probability that neither carrying nor borrowing occurs is 99.6% falling within 3σ of the normal distribution. However, in order to arbitrarily set relaxation and strictness of the condition, a parameter m that causes the probability to fall within ma (m>0) of the normal distribution may be introduced. In that case, Expression (27) is expressed as Expression (28).

$$\begin{matrix}[ Math . 24 ] & \\ {k}_{1}^{2} \frac{{c}_{0} + {c}_{1} ( {A}_{h} + B )}{{A}_{h}^{2}} + {k}_{h}^{2} \frac{{c}_{0} + {c}_{1} ( {A}_{1} + B )}{{A}_{1}^{2}} < {( \frac{π}{{mk}_{0}} )}^{2} & ( 28 )\end{matrix}$$

<4. Schematic Configuration Example of Distance Measurement System>

FIG. 8 is a block diagram showing a schematic configuration example of a distance measurement system to which the method of the present disclosure described above is applied.

A distance measurement system 10 of FIG. 8 is a system that measures a distance by the Indirect ToF method and includes a light source device 11 and the distance measurement device 12. The distance measurement system 10 irradiates an object with light, receives light (reflected light) as the light (irradiation light) reflected by the object 3 (FIG. 1), and therefore generates and outputs a depth map as information regarding a distance from the object 3. More specifically, the distance measurement system 10 emits irradiation light at two types of frequencies fₗ and fₕ (low frequency fₗ and high frequency fₕ), receives reflected light thereof, resolves the ambiguity of the number of cycles N by the method disclosed in Non-Patent Document 2, and calculates the true distance D from the object 3.

The distance measurement device 12 includes a light emission control unit 31, a distance measurement sensor 32, and a signal processing unit 33.

For example, the light source device 11 includes, as a light emission source 21, a vertical cavity surface emitting laser (VCSEL) array in which a plurality of VCSELs is arrayed in a planar manner, emits light while modulating the light at a timing corresponding to a light emission control signal supplied from the light emission control unit 31, and irradiates the object with irradiation light.

The light emission control unit 31 controls the light source device 11 by generating a light emission control signal having a predetermined modulation frequency (e.g., 100 MHz or the like) and supplying the signal to the light source device 11. Further, the light emission control unit 31 also supplies the light emission control signal to the distance measurement sensor 32 in order to drive the distance measurement sensor 32 in accordance with a timing of light emission in the light source device 11. The light emission control signal is generated on the basis of a drive parameter supplied from the signal processing unit 33. According to the method disclosed in Non-Patent Document 2, the two types of frequencies fₗ and fₕ (low frequency fₗ and high frequency fₕ) are sequentially set, and the light source device 11 sequentially emits irradiation light corresponding to the two types of frequencies fₗ and fₕ.

The distance measurement sensor 32 is a pixel array in which a plurality of pixels is two-dimensionally arranged and receives the reflected light from the object 3. Then, then, the distance measurement sensor 32 supplies pixel data including a detection signal corresponding to an amount of the received reflected light to the signal processing unit 33 in units of pixels of the pixel array.

The signal processing unit 33 receives the reflected light corresponding to the irradiation light of the two types of frequencies fₗ and fₕ, resolves the ambiguity of the number of cycles N by the method disclosed in Non-Patent Document 2, and calculates the true distance D from the object 3.

Further, the signal processing unit 33 calculates a depth value that is a distance from the distance measurement system 10 to the object 3 on the basis of the pixel data supplied from the distance measurement sensor 32 for each pixel of the pixel array, generates a depth map in which the depth value is stored as a pixel value of each pixel, and outputs the depth map to the outside of a module. Furthermore, the signal processing unit 33 also generates a confidence map in which the confidence conf is stored as the pixel value of each pixel and outputs the confidence map to the outside of the module.

<5. Detailed Configuration Example of Signal Processing Unit>

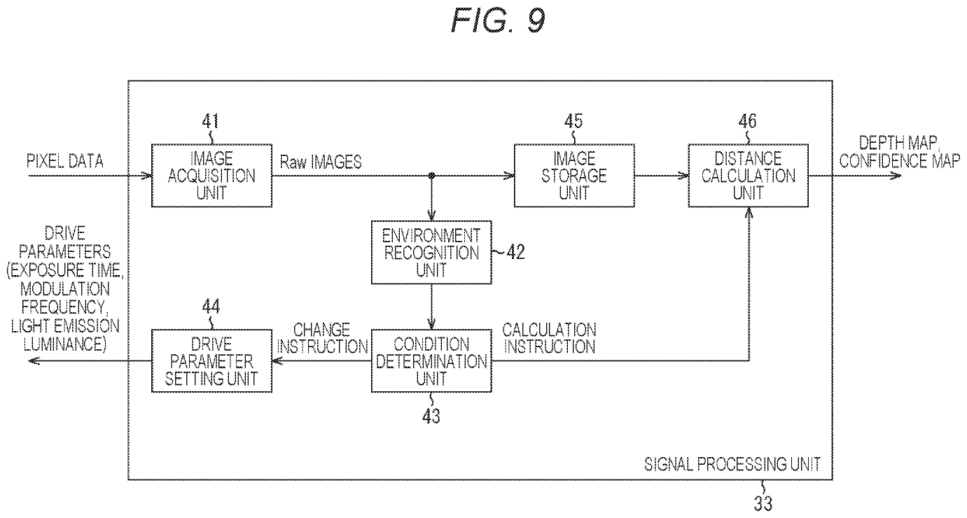

FIG. 9 is a block diagram showing a detailed configuration example of the signal processing unit 33 of the distance measurement device 12.

The signal processing unit 33 includes an image acquisition unit 41, an environment recognition unit 42, a condition determination unit 43, a drive parameter setting unit 44, an image storage unit 45, and a distance calculation unit 46.

The image acquisition unit 41 accumulates, in units of frames, pixel data supplied from the distance measurement sensor 32 for each pixel of the pixel array and supplies the pixel data as a raw image in units of frames to the environment recognition unit 42 and the image storage unit 45. For example, in a case where the distance measurement sensor 32 includes two charge accumulation units in each pixel of the pixel array, two types of detection signals having the phase of 0 degrees and the phase of 180 degrees or two types of detection signals having the phase of 90 degrees and the phase of 270 degrees are sequentially supplied to the image acquisition unit 41 as the pixel data. The image acquisition unit 41 generates a raw image having the phase of 0 degrees and a raw image having the phase of 180 degrees from the detection signals having the phase of 0 degrees and the phase of 180 degrees in each pixel of the pixel array and supplies the raw images to the environment recognition unit 42 and the image storage unit 45. Further, the image acquisition unit 41 generates a raw image having the phase of 90 degrees and a raw image having the phase of 270 degrees from the detection signals having the phase of 90 degrees and the phase of 270 degrees in each pixel of the pixel array and supplies the raw images to the environment recognition unit 42 and the image storage unit 45.

The environment recognition unit 42 recognizes a measurement environment by using the raw images of the four phases supplied from the image acquisition unit 41. Specifically, the environment recognition unit 42 calculates, in units of pixels, the amplitude A of the reflected light calculated from Expression (5) and the magnitude B of the ambient light calculated from Expression (6) by using the raw images of the four phases and supplies the calculated amplitude A and magnitude B to the condition determination unit 43. The amplitude A of the reflected light and the magnitude B of the ambient light thus calculated are supplied to the condition determination unit 43.

By using the amplitude A of the reflected light and the magnitude B of the ambient light supplied from the environment recognition unit 42, the condition determination unit 43 determines whether or not the current measurement environment satisfies the conditional expression in which neither carrying nor borrowing occurs due to noise in the calculation of the number of cycles Nₗ of Expression (11) (number-of-cycles determination expression) disclosed in Non-Patent Document 2. That is, the condition determination unit 43 determines whether or not the current measurement environment satisfies the condition of Expression (28) (Expression (27) when m=3). In a case where the condition determination unit 43 determines that it is necessary to change the drive parameter on the basis of the determination result, the condition determination unit 43 supplies an instruction to change the drive parameter to the drive parameter setting unit 44. Meanwhile, in a case where the condition determination unit 43 determines that it is unnecessary to change the drive parameter on the basis of the determination result, the condition determination unit 43 supplies an instruction to calculate a map to the distance calculation unit 46.

In a case where the instruction to change the drive parameter is supplied from the condition determination unit 43, the drive parameter setting unit 44 sets the changed drive parameter and supplies the drive parameter to the light emission control unit 31. The drive parameter set herein includes the two types of frequencies fₗ and fₕ when the light emission source 21 of the light source device 11 emits irradiation light, an exposure time for each phase when the distance measurement sensor 32 performs exposure, a light emission period and light emission luminance when the light source device 11 emits light, and the like. The light emission period also corresponds to the exposure time of the distance measurement sensor 32. The light emission luminance can also be adjusted by controlling the light emission period. The light emission control unit 31 generates a light emission control signal on the basis of the drive parameter supplied from the drive parameter setting unit 44.

In a case where the determination result that the condition of Expression (28) is not satisfied is supplied from the condition determination unit 43, the drive parameter setting unit 44 sets (changes) the drive parameter such that an amount of light emission of the irradiation light having the high frequency fₕ is smaller than that of the irradiation light having the low frequency fₗ. When the low frequency fₗ<the high frequency fₕ is satisfied, kₕ>kₗ is established when k; and kₗ in Expression (28) are compared. Therefore, it is easier to make the left side of Expression (28) smaller by greatly changing an amplitude Aₗ having kₕ as a coefficient than by changing an amplitude Aₕ having kₗ as the coefficient.

Meanwhile, in a case where the determination result that the condition of Expression (28) is satisfied is supplied, the drive parameter setting unit 44 may set (change) the drive parameter so as to reduce power consumption while satisfying the condition of Expression (28). In this case, for example, the drive parameter setting unit 44 makes the amplitude Aₕ having kₗ as the coefficient smaller.

The image storage unit 45 receives the raw image of each phase at the low frequency fₗ and the raw image of each phase at the high frequency fₕ supplied from the image acquisition unit 41. The image storage unit 45 temporarily stores the raw images supplied from the image acquisition unit 41. In response to a request from the distance calculation unit 46, the image storage unit 45 supplies the stored raw image of each phase at the low frequency fₗ and the stored raw image of each phase at the high frequency fₕ to the distance calculation unit 46. In a case where the drive parameter is changed and raw images having the changed drive parameter are supplied from the image acquisition unit 41, the image storage unit 45 overwrites and stores the latest raw images of each frequency, i.e., of the low frequency fₗ and the high frequency fₕ.

In a case where the instruction to calculate a map is supplied from the condition determination unit 43, the distance calculation unit 46 acquires the raw image of each phase at the low frequency fₗ and the raw image of each phase at the high frequency fₕ stored in the image storage unit 45. The acquired raw images are raw images of the four phases at each of the two types of frequencies f satisfying the condition of Expression (28). By using the raw images of the four phases at each of the two types of frequencies f, the distance calculation unit 46 determines the number of cycles Nₗ by the method disclosed in Non-Patent Document 2, specifically, from Expression (11) and calculates the true distance D from the object 3.

Further, the distance calculation unit 46 generates a depth map in which the depth value (true distance D) is stored as the pixel value of each pixel and a confidence map in which the confidence conf is stored as the pixel value thereof and outputs the depth map and the confidence map to the outside of the module.

<6. Processing Flow of First Distance Measurement Processing>

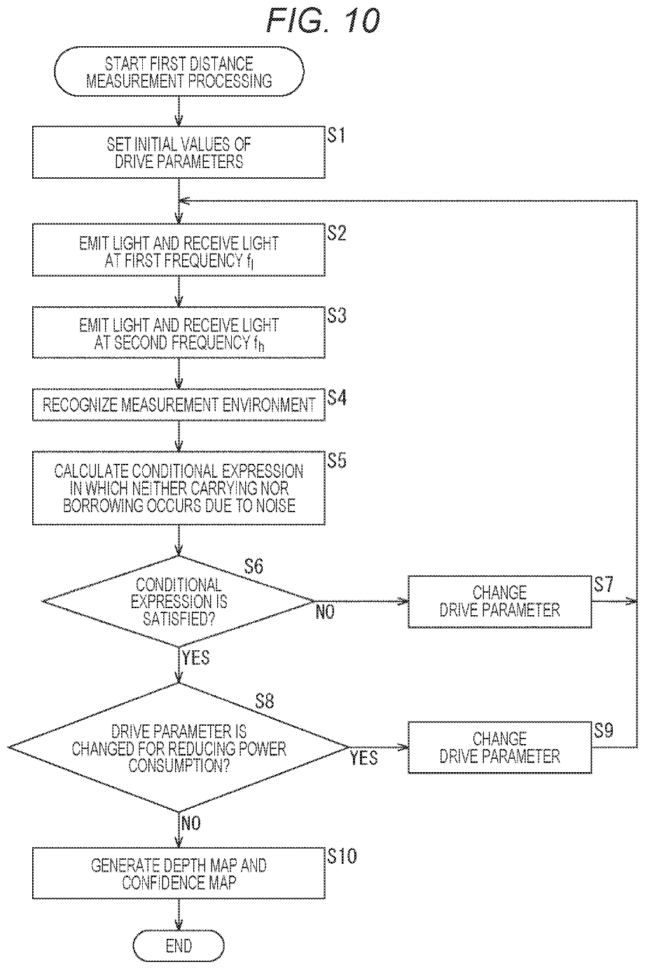

First distance measurement processing by the distance measurement system 10 of FIG. 8 will be described with reference to a flowchart of FIG. 10. This processing is started when, for example, the distance measurement system 10 is instructed to execute distance measurement.

First, in step S1, the drive parameter setting unit 44 sets initial values of drive parameters and supplies the initial values to the light emission control unit 31. As the initial values of the drive parameters, a first frequency f_{l_0} (low frequency f_{l_0}) at which the light emission source 21 of the light source device 11 emits irradiation light, a second frequency f_{h_0} (high frequency f_{h_0}) higher than the first frequency f_{l_0}, and an exposure time EXP₀ for each phase when the distance measurement sensor 32 performs exposure are set, and the initial values are supplied to the light emission control unit 31.

In step S2, the light source device 11 and the distance measurement sensor 32 emit light and receive light at the first frequency fₗ (low frequency fₗ).

In the processing of step S2, the light emission control unit 31 generates a light emission control signal having the first frequency fₗ (low frequency fₗ) and supplies the light emission control signal to the light source device 11 and the distance measurement sensor 32. The light source device 11 emits light while modulating the light at a timing corresponding to the light emission control signal having the first frequency fₗ, thereby irradiating an object with irradiation light. The distance measurement sensor 32 receives reflected light at the timing corresponding to the light emission control signal having the first frequency fₗ and supplies pixel data including a detection signal corresponding to an amount of the received light to the signal processing unit 33 in units of pixels of the pixel array.

As described with reference to FIG. 2, the distance measurement sensor 32 receives the reflected light at timings of the four phases, i.e., the phase of 0 degrees, the phase of 90 degrees, the phase of 180 degrees, and the phase of 270 degrees with respect to the light emission timing of the light source device 11 and supplies the pixel data to the signal processing unit 33. The signal processing unit 33 generates raw images of the four phases at the first frequency fₗ and supplies the raw images to the environment recognition unit 42 and the image storage unit 45.

In step S3, the light source device 11 and the distance measurement sensor 32 emit light and receive light at the second frequency fₕ (high frequency fₕ). The processing of step S3 is similar to the processing of step S2, except that the modulation frequency is changed from the first frequency fₗ to the second frequency fₕ. Note that the order of the processing in steps S2 and S3 may be reversed.

In step S4, the environment recognition unit 42 recognizes a measurement environment by using the raw images of the four phases supplied from the image acquisition unit 41. The environment recognition unit 42 calculates, in units of pixels, the amplitude A of the reflected light calculated from Expression (5) and the magnitude B of the ambient light calculated from Expression (6) by using the raw images of the four phases and supplies the calculated amplitude A and magnitude B to the condition determination unit 43. The amplitude A of the reflected light and the magnitude B of the ambient light thus calculated are supplied to the condition determination unit 43.

In step S5, the condition determination unit 43 calculates the conditional expression in which neither carrying nor borrowing occurs due to noise in the calculation of the number of cycles Nₗ in Expression (11) disclosed in Non-Patent Document 2.

In step S6, the condition determination unit 43 determines whether or not the conditional expression in which neither carrying nor borrowing occurs due to noise, that is, whether or not the conditional expression in Expression (28) (Expression (27) when m=3) is satisfied.

In a case where it is determined in step S6 that the conditional expression in which neither carrying nor borrowing occurs due to noise is not satisfied, the processing proceeds to step S7, and the condition determination unit 43 supplies an instruction to change the drive parameters to the drive parameter setting unit 44. The instruction to change the drive parameters also includes a value of a specific drive parameter to be changed to satisfy the condition. Examples of the type of specific drive parameter to be changed to satisfy the condition include the amplitude Aₗ corresponding to the light emission luminance of light emitted at the first frequency fₗ, the amplitude Aₕ corresponding to the light emission luminance of light emitted at the second frequency fₕ, and parameters kₕ and kₗ related to the first frequency fₗ and the second frequency fₕ. For example, the light emission luminance of the light emitted at the first frequency fₗ by the light source device 11 is greatly changed so as to increase the amplitude Aₗ. The drive parameter setting unit 44 changes the drive parameter in accordance with the instruction to change the drive parameter. The changed drive parameter is supplied to the light emission control unit 31. After step S7, the processing returns to step S2, and the processing in and after step S2 is executed again by using the changed drive parameter.

Meanwhile, in a case where it is determined in step S6 that the conditional expression in which neither carrying nor borrowing occurs due to noise is satisfied, the processing proceeds to step S8, and the condition determination unit 43 determines whether to change the drive parameters for reducing power consumption.

In a case where it is determined in step S8 that the drive parameters for reducing power consumption are to be changed, the processing proceeds to step S9, and the condition determination unit 43 supplies an instruction to change the drive parameters to the drive parameter setting unit 44. The instruction to change the drive parameters also includes a value of a specific parameter for reducing power consumption while satisfying the condition in Expression (28). For example, the light emission luminance of the light emitted at the second frequency fₕ by the light source device 11 is slightly changed so as to reduce the amplitude Aₕ. The drive parameter setting unit 44 changes the drive parameter in accordance with the instruction to change the drive parameter. The changed drive parameter is supplied to the light emission control unit 31. After step S9, the processing returns to step S2, and the processing in and after step S2 is executed again by using the changed drive parameter.

Meanwhile, in a case where it is determined in step S8 that the drive parameters for reducing power consumption are not to be changed, the processing proceeds to step S10, and the condition determination unit 43 supplies an instruction to calculate a map to the distance calculation unit 46. The distance calculation unit 46 generates a depth map and a confidence map on the basis of the instruction to calculate a map from the condition determination unit 43. Specifically, the distance calculation unit 46 acquires the raw image of each phase at the low frequency fₗ and the raw image of each phase at the high frequency fₕ stored in the image storage unit 45. Then, the distance calculation unit 46 determines the number of cycles Nₗ from Expression (11) and calculates the true distance D from the object 3. Further, the distance calculation unit 46 generates a depth map in which the depth value (true distance D) is stored as the pixel value of each pixel and a confidence map in which the confidence conf is stored as the pixel value thereof and outputs the depth map and the confidence map to the outside of the module.

Thus, the first distance measurement processing ends.

According to the first distance measurement processing described above, it is possible to prevent erroneous detection of the number of cycles N and calculate an accurate depth value d in the method disclosed in Non-Patent Document 2 that resolves the ambiguity of the number of cycles N on the basis of a result of distance measurement performed by using two frequencies, i.e., the first frequency fₗ (low frequency fₗ) and the second frequency fₕ (high frequency fₕ) higher than the first frequency fₗ.

Further, it is possible to prevent erroneous detection of the number of cycles N and measure a distance while reducing power consumption by controlling drive parameters, such as the light emission luminance and the frequency when the light source device 11 emits light and the exposure time of the distance measurement device 12, so as to reduce power consumption within a range in which the number of cycles N is not erroneously detected. Because the distance can be measured with a smaller amount of light emission and exposure, it is possible to measure a long distance with reduced power consumption. Further, an effect of the scattering effect caused by overexposure can be reduced.

<Expansion of Measurement Distance by HDR Synthesis>

As a distance measurement method using two depth maps having different frequencies, there is known processing of synthesizing a first depth map of a first frequency and a second depth map of a second frequency and generating a depth map having an expanded dynamic range (measurement range) (hereinafter, referred to as an HDR depth map). In the HDR depth map generation processing, a luminance difference is set between the light emission luminance used to acquire the first depth map and the light emission luminance used to acquire the second depth map. In general, a distance measurement range is shorter as the frequency is higher, and the intensity of light is inversely proportional to the square of a distance. By using those properties, the light emission luminance of light emitted at a high modulation frequency is reduced to measure a short distance, whereas the light emission luminance of light emitted at a low modulation frequency is increased to measure a long distance.

The distance measurement device 12 can also generate a depth map and a confidence map for each of the two different types of frequencies as described above, and thus it is possible to generate an HDR depth map having an expanded dynamic range by using two depth maps having different frequencies.

Specifically, the distance calculation unit 46 of the distance measurement device 12 can generate an HDR depth map having an expanded dynamic range by controlling the light emission luminance of light emitted at the first frequency fₗ (low frequency fₗ) to first light emission luminance to thereby generate a first depth map and controlling the light emission luminance of light emitted at the second frequency fₕ (high frequency fₕ) to second light emission luminance smaller than the first light emission luminance to thereby generate a second depth map.

Also in the HDR depth map generation processing, the signal processing unit 33 can determine whether or not the condition of Expression (28) is satisfied and control the drive parameters such that neither carrying nor borrowing occurs due to noise. Further, it is also possible to control the drive parameters for reducing power consumption while satisfying the condition of Expression (28).

Also in the control of the drive parameters in the HDR depth map generation processing, it is easier to make the left side of Expression (28) smaller by greatly changing the amplitude Ai having kₕ as the coefficient than by changing the amplitude Aₕ having kₗ as the coefficient. Further, in a case where the drive parameter is changed to reduce power consumption while satisfying the condition of Expression (28), it is possible to make the amplitude Aₕ having kₗ as the coefficient smaller. In the HDR depth map generation processing for setting a large sensitivity difference between the low frequency fₗ and the high frequency fₕ, the sensitivity difference can be easily set because it is possible to find how much the light emission intensity and the exposure period can be reduced on the basis of the condition of Expression (28).

<7. Processing Flow of Second Distance Measurement Processing>

Next, second distance measurement processing by the distance measurement system 10 will be described.

The environment recognition unit 42 calculates the amplitude A of the reflected light calculated from Expression (5) and the magnitude B of the ambient light calculated from Expression (6) by using the raw images of the four phases. When the magnitude B of the ambient light is large, noise becomes relatively large with respect to the amplitude A, and thus the SN ratio decreases. Meanwhile, when the magnitude B of the ambient light is small, the SN ratio is favorable.

Assuming that the first frequency fₗ is 60 MHz and the second frequency fₕ (fₗ<fₕ) is 100 MHz, one cycle of the first frequency fₗ is 2.5 m (=dₗ^{max}), and one cycle of the second frequency fₕ is 1.5 m (=dₕ^{max}). Therefore, because of the combination of the two types of frequencies and the resolution of the ambiguity of the number of cycles N described above, the first to third cycles can be distinguished when, for example, driving at the first frequency fₗ is set as a reference. Thus, a distance up to 7.5 m can be measured. A maximum distance that can be substantially measured by combining the two types of frequencies and resolving the ambiguity of the number of cycles N will be referred to as an effective distance dₑ^{max}=7.5 m. The effective distance dₑ^{max} is determined by an effective frequency fₑ=gcd(fₕ, fₗ) that is the greatest common divisor of fₕ and fₗ, which is equal to dₑ^{max}=c/2fₑ. In order to further increase the effective distance dₑ^{max}, it is only required to adopt a combination {fₗ, fₕ} of the first frequency fₗ and the second frequency fₕ for reducing the effective frequency fₑ=gcd(fₕ, fₗ). However, as the effective frequency fₑ=gcd(fₕ, fₗ) is smaller and the effective distance dₑ^{max} is larger, an error occurring in the number of cycles N increases when an error occurs due to noise.

In the second distance measurement processing by the distance measurement system 10, the condition determination unit 43 calculates, as an evaluation value, a score in Expression (26) below obtained by deforming Expression (25) and determines an influence of the ambient light on the basis of the score. In a scene where the influence of the ambient light is large, the condition determination unit 43 adopts a combination {fₗ, fₕ} of the first frequency fₗ and the second frequency fₕ for increasing the effective frequency fₑ, thereby reducing the effective distance dₑ^{max}. Meanwhile, in a scene where the influence of the ambient light is small, the condition determination unit 43 adopts a combination {fₗ, fₕ} of the first frequency fₗ and the second frequency fₕ for reducing the effective frequency fₑ, thereby increasing the effective distance dₑ^{max}.

$$\begin{matrix}[ Math . 25 ] & \\ Score = {( \frac{π}{{mk}_{0}} )}^{2} - ( {k}_{1}^{2} \frac{{c}_{0} + {c}_{1} ( {A}_{h} + B )}{{A}_{h}^{2}} + {k}_{h}^{2} \frac{{c}_{0} + {c}_{1} ( {A}_{1} + B )}{{A}_{1}^{2}} ) & ( 29 )\end{matrix}$$

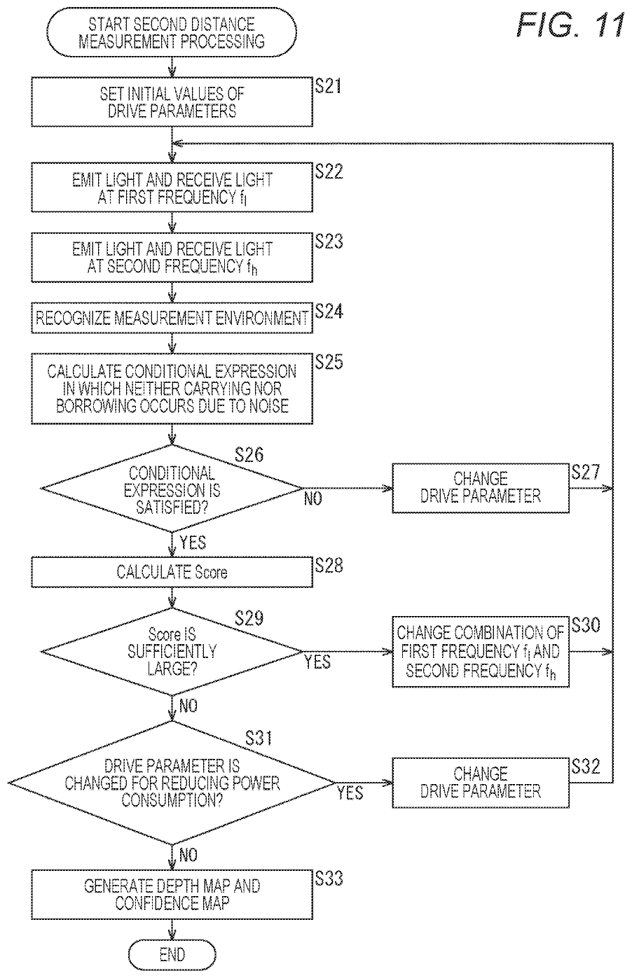

The second distance measurement processing by the distance measurement system 10 of FIG. 8 will be described with reference to a flowchart of FIG. 11.

Steps S21 to S27 in FIG. 11 are the same as steps S1 to S7 in FIG. 10, and steps S31 to S33 in FIG. 11 are the same as steps S8 to S10 in FIG. 10, and thus description of the processing in those steps will be omitted.

In other words, the second distance measurement processing of FIG. 11 is processing in which processing of steps S28 to S30 in FIG. 11 are added between steps S6 and S8 in the first distance measurement processing of FIG. 10.

In a case where it is determined in step S26 of FIG. 11 that the conditional expression in which neither carrying nor borrowing occurs due to noise is satisfied, the processing proceeds to step S28, and the condition determination unit 43 calculates the score of Expression (29).

Then, in step S29, the condition determination unit 43 determines whether or not a calculation result of the score is sufficiently large. In step S29, for example, in a case where the calculation result of the score is a predetermined threshold or more, it is determined that the calculation result of the score is sufficiently large.

In a case where it is determined in step S29 that the calculation result of the score is sufficiently large, the processing proceeds to step S30, and the condition determination unit 43 determines a drive parameter to be changed and supplies an instruction to change the drive parameter to the drive parameter setting unit 44. The instruction to change the drive parameters also includes a value of a specific drive parameter to be changed. The drive parameter setting unit 44 changes the combination {fₗ, fₕ} of the first frequency fₗ and the second frequency fₕ on the basis of the instruction to change the drive parameter. More specifically, the combination {fₗ, fₕ} of the first frequency fₗ and the second frequency fₕ is changed to reduce the effective frequency fₑ=gcd(fₕ, fₗ) and increase the effective distance dₑ^{max}. The condition determination unit 43 can store a plurality of combinations {fₗ, fₕ} of the first frequency fₗ and the second frequency fₕ having different effective distances dₑ^{max} in an internal memory in advance, selects, from among the combinations, a combination {fₗ, fₕ} of the first frequency fₗ and the second frequency fₕ having the effective distance dₑ^{max} larger than that of the current combination, and designates the combination to the drive parameter setting unit 44. After step S30, the processing returns to step S22, and the processing in and after step S22 is executed again by using the changed drive parameter.

Meanwhile, in a case where it is determined in step S29 that the calculation result of the score is not sufficiently large, the processing proceeds to step S31, and the condition determination unit 43 determines whether to change the drive parameters for reducing power consumption. Steps S31 to S33 are the same as steps S8 to S10 in FIG. 10.

Thus, the second distance measurement processing ends.

According to the second distance measurement processing described above, as well as the first distance measurement processing, it is possible to prevent erroneous detection of the number of cycles N and calculate the accurate depth value d in the method of resolving the ambiguity of the number of cycles N disclosed in Non-Patent Document 2. Further, it is possible to measure a distance while reducing power consumption within a range in which the number of cycles N is not erroneously detected.

Furthermore, according to the second distance measurement processing, the measurement environment is recognized, and a combination {fₗ, fₕ} of the first frequency fₗ and the second frequency fₕ for increasing the effective frequency fₑ can be adopted to reduce the effective distance dₑ^{max} in a scene where the influence of the ambient light is large, and a combination {fₗ, fₕ} of the first frequency fₗ and the second frequency fₕ for reducing the effective frequency fₑ can be adopted to increase the effective distance dₑ^{max} in a scene where the influence of the ambient light is small.

<Modification Example of Second Distance Measurement Processing>

In the second distance measurement processing described above, the combination {fₗ, fₕ} of the first frequency fₗ and the second frequency fₕ is changed to increase the effective distance dₑ^{max} in a case where the calculation result of the score in Expression (29) is sufficiently large. However, the processing may be performed such that the combination {fₗ, fₕ} is changed not to change the effective distance dₑ^{max} but to reduce noise, in other words, to improve the SN ratio.

For example, a combination of low frequencies {fₗ, fₕ}={40, 60} in which the first frequency fₗ is 40 MHz and the second frequency fₕ (fₗ<fₕ) is 60 MHz and a combination of high frequencies {fₗ, fₕ}={60, 100} in which the first frequency fₗ is 60 MHz and the second frequency fₕ (fₗ<fₕ) is 100 MHz both have the effective frequency fₑ=gcd(fₕ, fₗ)=20 MHz. Thus, the effective distances thereof are the same, i.e., dₑ^{max}=7.5 m.

However, the calculation result of the score in Expression (29) is larger in the combination of low frequencies {fₗ, fₕ}={40, 60}. Note, however, that this just indicates that an ability to resolve the ambiguity of the number of cycles N is high, but the obtained depth value d includes large noise. Meanwhile, in the combination of high frequencies {fₗ, fₕ}={60, 100}, a possibility that an error occurs in the resolution of the ambiguity of the number of cycles N is higher than that in the combination of low frequencies, but the noise in the obtained depth value d is smaller than that in the combination of low frequencies.

In step S30 executed in a case where it is determined in step S29 that the calculation result of the score is sufficiently large, the condition determination unit 43 supplies, to the drive parameter setting unit 44, an instruction to change the drive parameter to a combination of the frequencies {fₗ, fₕ} for not changing the effective distance dₑ^{max} (effective frequency fₑ) but reducing noise, in other words, improving the SN ratio.

According to the modification example of the second distance measurement processing, a combination {fₗ, fₕ} of the first frequency fₗ and the second frequency fₕ is adopted such that at least one of the first frequency fₗ or the second frequency fₕ becomes higher than before in a scene where the influence of the ambient light is small. Thus, it is possible to acquire a depth map having a favorable SN ratio.

<8. Application to Three or More Frequencies>

The first distance measurement processing, the second distance measurement processing, and the modification example thereof described above are examples of processing using the two types of frequencies, i.e., the first frequency fₗ and the second frequency fₕ (fₗ<fₕ), but is applicable to processing using three or more types of frequencies.

For example, in a case where the first distance measurement processing described above is executed by using three types of frequencies, i.e., by using not only the first frequency fₗ and the second frequency fₕ (fₗ<fₕ), but also a third frequency fₘ (fₗ<fₘ<fₕ), the distance measurement system 10 can execute processing as follows.

First, the distance measurement system 10 executes the first distance measurement processing described above by using the first frequency fₗ and the third frequency fₘ. The first distance measurement processing is executed by replacing the second frequency fₕ in the first distance measurement processing of FIG. 10 with the second frequency fₕ. In a case where the first frequency fₗ and the third frequency fₘ are used, a depth map and a confidence map are generated by performing distance measurement at an effective frequency f_{e(l, m)}=gcd(fₗ, fₘ).

Next, the distance measurement system 10 executes the first distance measurement processing described above by using the effective frequency f_{e(l, m)} and the second frequency fₕ. The first distance measurement processing is executed by replacing the first frequency fₗ of the first distance measurement processing of FIG. 10 with the effective frequency f_{e(l, m)}. In a case where the effective frequency f_{e(l, m)} and the second frequency fₕ are used, a depth map and a confidence map are generated by performing distance measurement at the effective frequency fₑ=gcd(fₕ, gcd(fₗ, fₘ)).

By determining whether or not the conditional expression in Expression (28) is satisfied in the first distance measurement processing executed twice, it is possible to prevent erroneous detection of the number of cycles N and calculate the accurate depth value d. Further, it is possible to prevent erroneous detection of the number of cycles N and measure a distance while reducing power consumption by controlling the drive parameter so as to reduce power consumption within a range in which the number of cycles N is not erroneously detected.

<9. Application Example of Application>

The above-described distance measurement processing by the distance measurement system 10 can be applied to, for example, 3D modeling processing in which a distance in a depth direction of an indoor space is measured to generate a 3D model of the indoor space. Because of an increase in measurement distance by the HDR synthesis, it is possible to simultaneously measure not only a distance in a room but also a distance from an object in the room. In the measurement of the distance in the depth direction of the indoor space, it is also possible to set a combination of frequencies that makes the SN ratio favorable in accordance with an influence of ambient light or the like.

Further, the above-described distance measurement processing by the distance measurement system 10 can be used for generating environment mapping information when an autonomous robot, a mobile conveyance device, a flight device such as a drone, or the like performs localization by simultaneous localization and mapping (SLAM) or the like.

<10. Configuration Example of Chip of Distance Measurement Device>

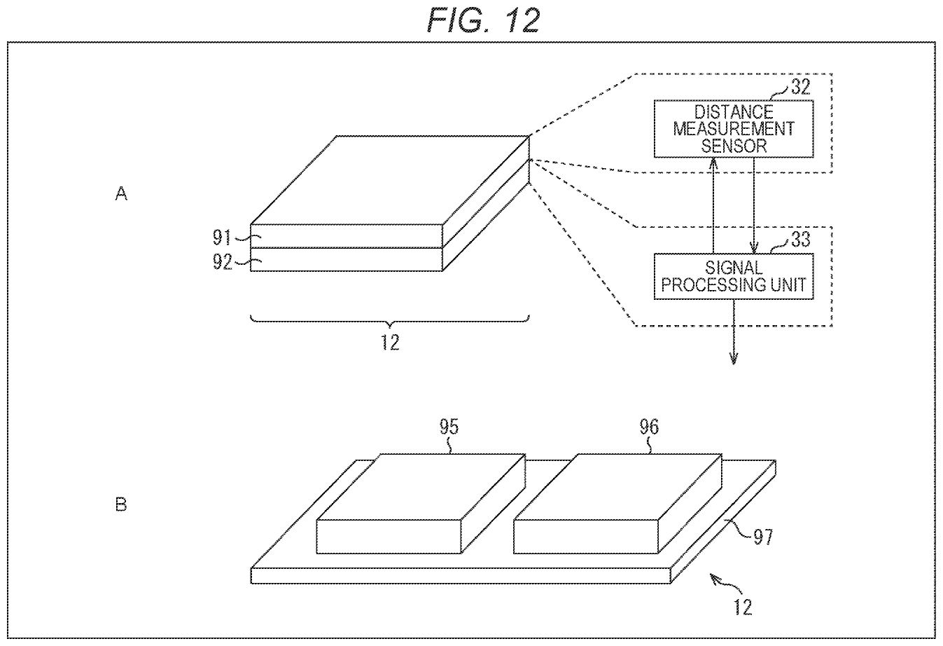

FIG. 12 is a perspective view illustrating a configuration example of a chip of the distance measurement device 12.

As illustrated in A of FIG. 12, the distance measurement device 12 can be formed as one chip in which a first die (substrate) 91 and a second die (substrate) 92 are laminated.

For example, the light emission control unit 31 and the distance measurement sensor 32 are formed in the first die 91, and, for example, the signal processing unit 33 is formed in the second die 92.

Note that the distance measurement device 12 may be formed by laminating three layers, i.e., the first die 91, the second die 92, and, in addition, another logic die, or may be formed by laminating four or more dies (substrates).

Further, for example, as illustrated in B of FIG. 12, the distance measurement device 12 may be formed by providing the light emission control unit 31 and the distance measurement sensor 32 and the signal processing unit 33 as different devices (chips). The light emission control unit 31 and the distance measurement sensor 32 are formed on a first chip 95 serving as a distance measurement sensor, the signal processing unit 33 is formed on a second chip 96 serving as a signal processing device, and the first chip 95 and the second chip 96 are electrically connected via a relay substrate 97.

<11. Configuration Example of Electronic Device>

The above-described distance measurement system 10 can be mounted on electronic devices such as, for example, a smartphone, a tablet terminal, a mobile phone, a personal computer, a game console, a television receiver, a wearable terminal, a digital still camera, and a digital video camera.

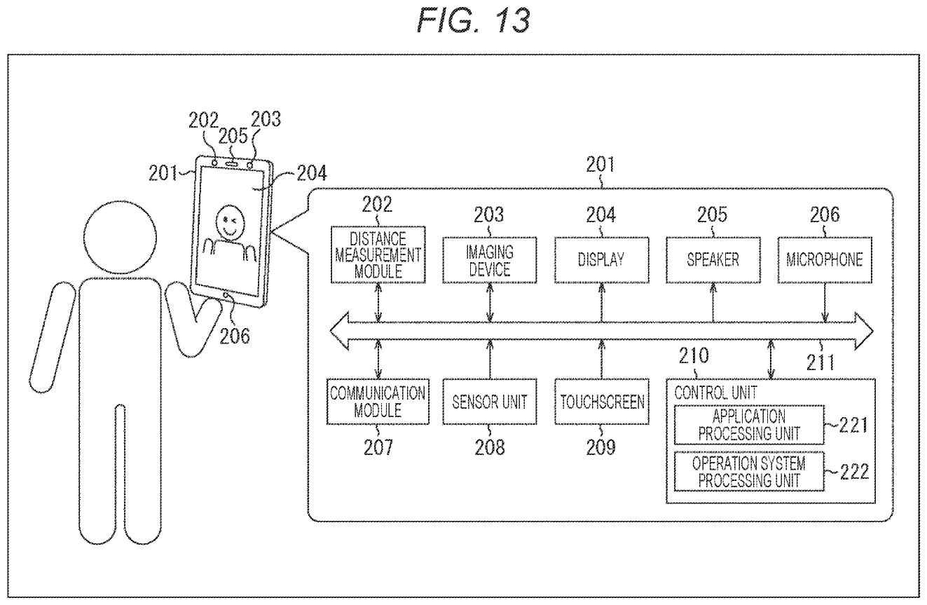

FIG. 13 is a block diagram showing a configuration example of a smartphone serving as the electronic device including the distance measurement system 10.

As shown in FIG. 13, a smartphone 201 is configured by connecting a distance measurement module 202, an imaging device 203, a display 204, a speaker 205, a microphone 206, a communication module 207, a sensor unit 208, a touchscreen 209, and a control unit 210 via a bus 211. Further, the control unit 210 causes a CPU to execute programs, thereby functioning as an application processing unit 221 and an operation system processing unit 222.

The distance measurement system 10 of FIG. 8 is applied to the distance measurement module 202. For example, the distance measurement module 202 is arranged on a front surface of the smartphone 201 and measures a distance from a user of the smartphone 201 and can therefore output a depth value of a surface shape of a face, hand, finger, or the like of the user as a distance measurement result.

The imaging device 203 is arranged on the front surface of the smartphone 201 and images the user of the smartphone 201 as a subject to acquire an image in which the user appears. Note that, although not shown, the imaging device 203 may also be arranged on a back surface of the smartphone 201.

The display 204 displays an operation screen for performing processing by the application processing unit 221 and the operation system processing unit 222, an image captured by the imaging device 203, and the like. The speaker 205 and the microphone 206 output voice of the other party and collect voice of the user when the user is talking by using the smartphone 201, for example.

The communication module 207 performs communication via a communication network. The sensor unit 208 senses speed, acceleration, proximity, and the like. The touchscreen 209 acquires a touch operation by the user on an operation screen displayed on the display 204.

The application processing unit 221 performs processing for allowing the smartphone 201 to provide various services. For example, the application processing unit 221 can perform processing of creating a face by virtually reproducing expression of the user by using computer graphics on the basis of a depth supplied from the distance measurement module 202 and displaying the face on the display 204. Further, the application processing unit 221 can perform processing of creating, for example, three-dimensional shape data of an arbitrary three-dimensional object on the basis of the depth supplied from the distance measurement module 202.

The operation system processing unit 222 performs processing for implementing basic functions and operations of the smartphone 201. For example, the operation system processing unit 222 can perform processing of authenticating the face of the user on the basis of the depth value supplied from the distance measurement module 202 and unlocking the smartphone 201. Further, the operation system processing unit 222 can perform, for example, processing of recognizing a gesture of the user on the basis of the depth value supplied from the distance measurement module 202 and processing of inputting various operations according to the gesture.

By applying the above-described distance measurement system 10 to the smartphone 201 configured as described above, it is possible to generate a depth map with high accuracy, for example. Therefore, the smartphone 201 can more accurately detect distance measurement information.

<12. Configuration Example of Computer>

Next, a series of processing executed by the signal processing unit 33 described above can be performed by hardware or software. In a case where the series of processing is executed by software, a program forming the software is installed in a general-purpose computer or the like.

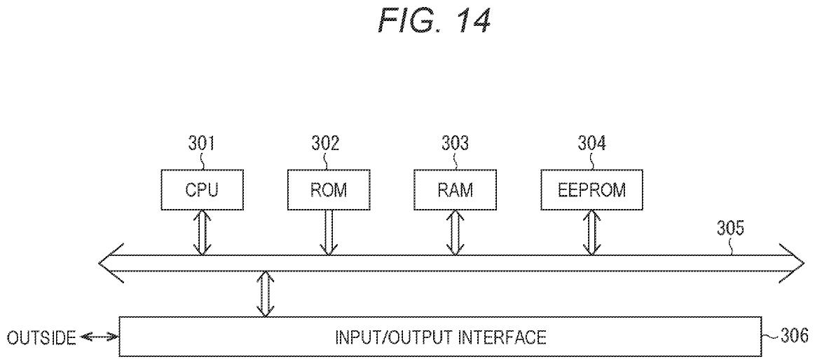

FIG. 14 is a block diagram showing a configuration example of an embodiment of a computer in which a program for executing the series of processing executed by the signal processing unit 33 is installed.

In the computer, a central processing unit (CPU) 301, a read only memory (ROM) 302, a random access memory (RAM) 303, and an electronically erasable and programmable read only memory (EEPROM) 304 are connected to one another by a bus 305. The bus 305 is further connected to an input/output interface 306, and the input/output interface 306 is connected to the outside.

In the computer configured as described above, for example, the series of processing described above is performed by, for example, the CPU 301 loading a program stored in the ROM 302 and the EEPROM 304 into the RAM 303 via the bus 305 and executing the program. Further, the program executed by the computer (CPU 301) can be written in advance in the ROM 302 or can be installed in the EEPROM 304 from the outside via the input/output interface 306 or can be updated.

Therefore, the CPU 301 performs the processing according to the flowcharts described above or the processing performed by the configuration of the block diagram described above. Then, the CPU 301 can output a result of the processing to, for example, the outside via the input/output interface 306 as necessary.

In the present specification, the processing performed by the computer according to the program is not necessarily performed in time series in the order shown in the flowcharts. That is, the processing performed by the computer according to the program also includes processing executed in parallel or individually (e.g., parallel processing or processing by an object).

Further, the program may be processed by a single computer (processor) or may be processed in a distributed manner by a plurality of computers. Further, the program may be transferred to a remote computer and be executed therein.

<13. Examples of Application to Moving Objects>

The technology according to the present disclosure (present technology) is applicable to various products. For example, the technology according to the present disclosure may be achieved as a device to be mounted on any type of moving objects such as an automobile, an electric vehicle, a hybrid electric vehicle, a motorcycle, a bicycle, a personal mobility, an airplane, a drone, a ship, and a robot.

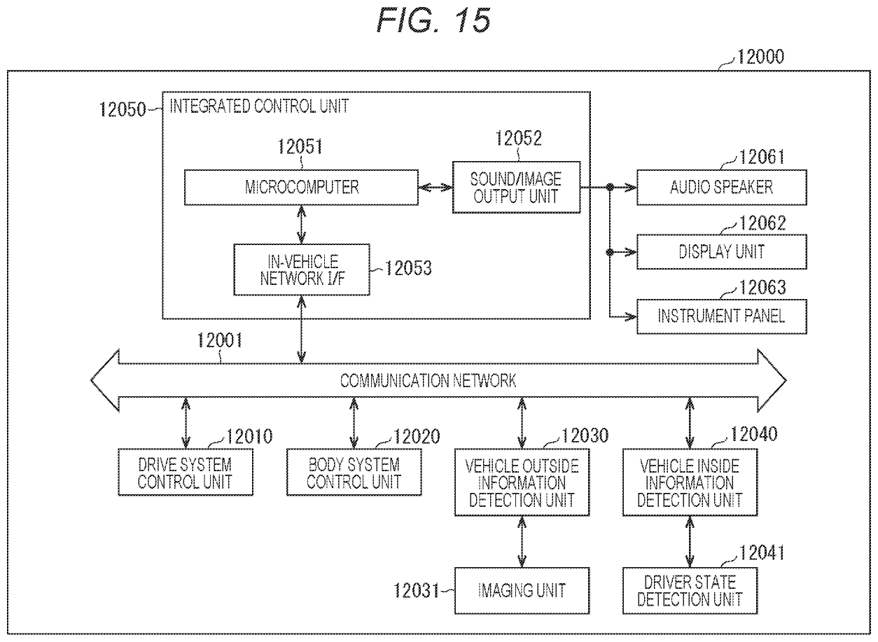

FIG. 15 is a block diagram showing a schematic configuration example of a vehicle control system that is an example of a moving object control system to which the technology according to the present disclosure is applicable.

A vehicle control system 12000 includes a plurality of electronic control units connected via a communication network 12001. In the example of FIG. 15, the vehicle control system 12000 includes a drive system control unit 12010, a body system control unit 12020, a vehicle outside information detection unit 12030, a vehicle inside information detection unit 12040, and an integrated control unit 12050. Further, the integrated control unit 12050 includes, as a functional configuration, a microcomputer 12051, a sound/image output unit 12052, and an in-vehicle network interface (I/F) 12053.

The drive system control unit 12010 controls operation of devices related to a drive system of a vehicle in accordance with various programs. For example, the drive system control unit 12010 functions as a control device for a driving force generator for generating driving force of the vehicle, such as an internal combustion engine or a driving motor, a driving force transmission mechanism for transmitting driving force to wheels, a steering mechanism for adjusting a steering angle of the vehicle, a braking device for generating braking force of the vehicle, and the like.

The body system control unit 12020 controls operation of various devices mounted on a vehicle body in accordance with various programs. For example, the body system control unit 12020 functions as a control device for a keyless entry system, a smart key system, a power window device, or various lamps such as a headlamp, a back lamp, a brake lamp, a blinker, and a fog lamp. In this case, radio waves transmitted from a portable device that substitutes for a key or signals of various switches can be input to the body system control unit 12020. The body system control unit 12020 accepts input of those radio waves or signals and controls the door lock device, the power window device, the lamps, and the like of the vehicle.

The vehicle outside information detection unit 12030 detects information regarding outside of the vehicle on which the vehicle control system 12000 is mounted. For example, the vehicle outside information detection unit 12030 is connected to an imaging unit 12031. The vehicle outside information detection unit 12030 causes the imaging unit 12031 to capture an image of the outside of the vehicle and receives the captured image. On the basis of the received image, the vehicle outside information detection unit 12030 may perform processing of detecting an object such as a person, a vehicle, an obstacle, a sign, or a character on a road surface or processing of detecting a distance.

The imaging unit 12031 is an optical sensor that receives light and outputs an electrical signal corresponding to an amount of the received light. The imaging unit 12031 can output the electrical signal as an image or as distance measurement information. Further, the light received by the imaging unit 12031 may be visible light or invisible light such as infrared rays.

The vehicle inside information detection unit 12040 detects information regarding inside of the vehicle. For example, the vehicle inside information detection unit 12040 is connected to a driver state detection unit 12041 that detects a state of a driver. The driver state detection unit 12041 includes, for example, a camera that captures an image of the driver, and, on the basis of detection information input from the driver state detection unit 12041, the vehicle inside information detection unit 12040 may calculate a degree of fatigue or concentration of the driver or determine whether or not the driver falls asleep.

The microcomputer 12051 can calculate a control target value of the driving force generator, the steering mechanism, or the braking device on the basis of the information regarding the inside and outside of the vehicle acquired by the vehicle outside information detection unit 12030 or the vehicle inside information detection unit 12040, and output a control command to the drive system control unit 12010. For example, the microcomputer 12051 can perform cooperative control for the purpose of realizing functions of an advanced driver assistance system (ADAS) including collision avoidance or impact attenuation of vehicles, following traveling based on a following distance, vehicle speed maintenance traveling, vehicle collision warning, vehicle lane departure warning, or the like.

Further, the microcomputer 12051 can perform cooperative control for the purpose of, for example, automated driving in which the vehicle automatedly travels without depending on the driver's operation by controlling the driving force generator, the steering mechanism, the braking device, or the like on the basis of information regarding surroundings of the vehicle acquired by the vehicle outside information detection unit 12030 or the vehicle inside information detection unit 12040.

Further, the microcomputer 12051 can output a control command to the body system control unit 12020 on the basis of the information regarding the outside of the vehicle acquired by the vehicle outside information detection unit 12030. For example, the microcomputer 12051 can perform cooperative control for the purpose of glare protection by, for example, controlling the headlamp in accordance with a position of a preceding vehicle or oncoming vehicle detected by the vehicle outside information detection unit 12030 to switch a high beam to a low beam.

The sound/image output unit 12052 transmits an output signal of at least one of sound or image to an output device capable of visually or aurally notifying a vehicle passenger or the outside of the vehicle of information. The example of FIG. 15 shows an audio speaker 12061, a display unit 12062, and an instrument panel 12063 as examples of the output device. The display unit 12062 may include, for example, at least one of an on-board display or a head-up display.

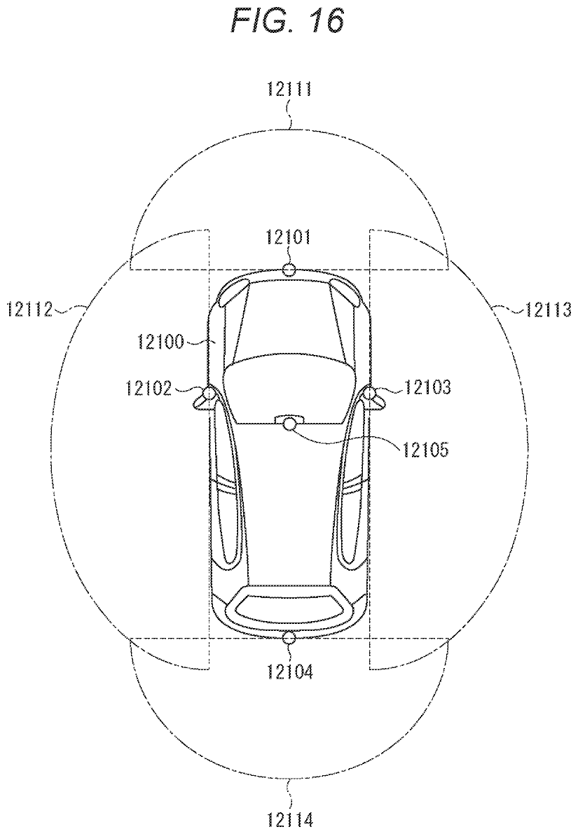

FIG. 16 shows an example of an installation position of the imaging unit 12031.

In FIG. 16, the vehicle 12100 includes imaging units 12101, 12102, 12103, 12104, and 12105 as the imaging unit 12031.

The imaging units 12101, 12102, 12103, 12104, and 12105 are provided at, for example, positions such as a front nose, a side mirror, a rear bumper, a back door, and an upper portion of a windshield in a vehicle interior of the vehicle 12100. The imaging unit 12101 provided at the front nose and the imaging unit 12105 provided at the upper portion of the windshield in the vehicle interior mainly acquire images of a front view of the vehicle 12100. The imaging units 12102 and 12103 provided at the side mirrors mainly acquire images of side views of the vehicle 12100. The imaging unit 12104 provided at the rear bumper or back door mainly acquires an image of a rear view of the vehicle 12100. The images of the front view acquired by the imaging units 12101 and 12105 are mainly used for detecting a preceding vehicle, a pedestrian, an obstacle, a traffic light, a traffic sign, a lane, and the like.

Note that FIG. 16 shows examples of imaging ranges of the imaging units 12101 to 12104. An imaging range 12111 indicates the imaging range of the imaging unit 12101 provided at the front nose. Imaging ranges 12112 and 12113 indicate the respective imaging ranges of the imaging units 12102 and 12103 provided at the side mirrors. An imaging range 12114 indicates the imaging range of the imaging unit 12104 provided at the rear bumper or back door. For example, an overhead image of the vehicle 12100 viewed from above is obtained by superimposing image data captured by the imaging units 12101 to 12104.

At least one of the imaging units 12101 to 12104 may have a function of acquiring distance information. For example, at least one of the imaging units 12101 to 12104 may be a stereo camera including a plurality of imaging elements, or may be an imaging element including pixels for phase difference detection.

For example, the microcomputer 12051 obtains a distance from each three-dimensional object within the imaging ranges 12111 to 12114 and a temporal change in this distance (relative speed to the vehicle 12100) on the basis of distance information obtained from the imaging units 12101 to 12104 and can therefore particularly extract, as a preceding vehicle, the closest three-dimensional object existing on a traveling path of the vehicle 12100 and traveling at a predetermined speed (e.g., 0 km/h or more) in substantially the same direction as the vehicle 12100. Further, the microcomputer 12051 can set a following distance from the preceding vehicle to be secured in advance and perform automatic brake control (including following stop control), automatic acceleration control (including following start control), and the like. Thus, it is possible to perform cooperative control for the purpose of, for example, automated driving in which the vehicle automatedly travels without depending on the driver's operation.

For example, the microcomputer 12051 can classify three-dimensional object data regarding three-dimensional objects into two-wheeled vehicles, standard vehicles, large vehicles, pedestrians, and other three-dimensional objects such as power poles on the basis of the distance information obtained from the imaging units 12101 to 12104, extract the three-dimensional object data, and therefore use the three-dimensional object data to automatically avoid obstacles. For example, the microcomputer 12051 identifies obstacles around the vehicle 12100 as obstacles that are noticeable for the driver of the vehicle 12100 and obstacles that are hardly noticeable therefor. Further, the microcomputer 12051 determines a collision risk indicating a risk of collision with each obstacle, and, when the collision risk is equal to or larger than a set value, i.e., in a state in which collision may occur, the microcomputer 12051 can perform driving assistance for collision avoidance by outputting an alarm to the driver via the audio speaker 12061 or the display unit 12062 or by performing forced deceleration or avoidance steering via the drive system control unit 12010.

At least one of the imaging units 12101 to 12104 may be an infrared camera that detects infrared rays. For example, the microcomputer 12051 can recognize a pedestrian by determining whether or not a pedestrian exists in the captured images of the imaging units 12101 to 12104. Such recognition of the pedestrian is carried out by performing, for example, a procedure for extracting feature points in the captured images of the imaging units 12101 to 12104 serving as infrared cameras and a procedure for performing pattern matching processing on a series of the feature points indicating an outline of an object to determine whether or not the object is a pedestrian. When the microcomputer 12051 determines that a pedestrian exists in the captured images of the imaging units 12101 to 12104 and recognizes the pedestrian, the sound/image output unit 12052 controls the display unit 12062 so that a rectangular outline for emphasis is displayed to be superimposed on the recognized pedestrian. Further, the sound/image output unit 12052 may control the display unit 12062 so that an icon or the like indicating the pedestrian is displayed at a desired position.

Hereinabove, an example of the vehicle control system to which the technology according to the present disclosure is applicable has been described. The technology according to the present disclosure is applicable to the vehicle outside information detection unit 12030 and the vehicle inside information detection unit 12040 among the configurations described above. Specifically, when distance measurement by the distance measurement system 10 is used by the vehicle outside information detection unit 12030 and the vehicle inside information detection unit 12040, processing of recognizing a gesture of the driver is performed, and thus it is possible to execute various operations (e.g., an audio system, a navigation system, and an air conditioning system) according to the gesture or more accurately detect the state of the driver. Further, by using the distance measurement by the distance measurement system 10, it is possible to recognize unevenness of a road surface and reflect the recognized unevenness in control of a suspension.

The embodiments of the present technology are not limited to the embodiments described above and can be variously modified without departing from the gist of the present technology.

A plurality of the present technologies described in the present specification can each be implemented alone independently as long as there is no contradiction. As a matter of course, a plurality of arbitrary present technologies can also be implemented in combination. For example, a part of or the entire present technology described in any embodiment can be implemented in combination with a part of or the entire present technology described in another embodiment. Further, a part of or the entire arbitrary present technology described above can also be implemented in combination with another technology not described above.

Further, for example, a configuration described as a single device (or processing unit) may be divided and configured as a plurality of devices (or processing units). On the contrary, in the above description, a configuration described as a plurality of devices (or processing units) may be integrally configured as a single device (or processing unit). Further, as a matter of course, a configuration other than the configurations described above may be added to the configuration of each device (or each processing unit). Furthermore, a part of a configuration of a certain device (or processing unit) may be included in a configuration of another device (or another processing unit) as long as a configuration or operation of the entire system is substantially the same.

Further, in the present specification, a system means a set of a plurality of components (devices, modules (parts), and the like), and it does not matter whether or not all the components are included in the same housing. Therefore, a plurality of devices included in separate housings and connected via a network and a single device including a plurality of modules in a single housing are both systems.

Note that the effects described in the present specification are merely illustrative and are not limited. Further, effects other than those described in the present specification may be obtained.

Note that the present technology can have the following configurations.

(1)

A signal processing device including:

a condition determination unit that determines whether or not a condition that neither carrying nor borrowing occurs is satisfied in a number-of-cycles determination expression for determining the number of cycles of 2π of either a first phase difference or a second phase difference, the first phase difference being detected by a distance measurement sensor when irradiation light is emitted at a first frequency, the second phase difference being detected by the distance measurement sensor when the irradiation light is emitted at a second frequency higher than the first frequency; and

a distance calculation unit that determines the number of cycles of 2π from the number-of-cycles determination expression in a case where it is determined that the condition is satisfied and calculates a distance from an object by using the first phase difference and the second phase difference.

(2)

The signal processing device according to (1), further including

a drive parameter setting unit that changes drive parameters of the distance measurement sensor and a light emission source that emits the irradiation light in a case where it is determined that the condition is not satisfied.

(3)

The signal processing device according to (2), in which

the drive parameter setting unit changes the drive parameters so as to increase an amount of light emission of the irradiation light having the first frequency.

(4)

The signal processing device according to (2) or (3), in which

the drive parameter setting unit changes the drive parameters of the distance measurement sensor and the light emission source that emits the irradiation light also in a case where it is determined that the condition is satisfied.

(5)

The signal processing device according to (4), in which

in a case where it is determined that the condition is satisfied, the drive parameter setting unit changes the drive parameters so as to reduce an amount of light emission of the irradiation light having the second frequency.

(6)

The signal processing device according to any one of (1) to (5), in which

in a case where it is determined that the condition is satisfied, the distance calculation unit determines the number of cycles of 2π from the number-of-cycles determination expression and generates a depth map by using the first phase difference and the second phase difference.

(7)

The signal processing device according to any one of (1) to (6), in which

in a case where it is determined that the condition is satisfied, the distance calculation unit synthesizes a first depth map of the first frequency and a second depth map of the second frequency and generates a depth map having an expanded dynamic range.

(8)

The signal processing device according to any one of (1) to (7), in which

the condition determination unit calculates an evaluation value for determining an influence of ambient light and determines a combination of the first frequency and the second frequency on the basis of the evaluation value.

(9)

The signal processing device according to (8), in which

in a case where the evaluation value is equal to or larger than a predetermined threshold, the condition determination unit determines the combination of the first frequency and the second frequency to be changed to increase an effective distance.

(10)

The signal processing device according to (8), in which

in a case where the evaluation value is equal to or larger than a predetermined threshold, the condition determination unit determines the combination of the first frequency and the second frequency such that at least one of the first frequency or the second frequency becomes larger than before.

(11)

The signal processing device according to any one of (1) to (10), in which

the condition determination unit determines whether or not the condition is satisfied in the number-of-cycles determination expression also by using a third frequency different from the first frequency or the second frequency, and

the distance calculation unit calculates the distance from the object also by using a third phase difference detected by the distance measurement sensor when the irradiation light is emitted at the third frequency.

(12)

A signal processing method, in which

a signal processing device

determines whether or not a condition that neither carrying nor borrowing occurs is satisfied in a number-of-cycles determination expression for determining the number of cycles of 2π of either a first phase difference or a second phase difference, the first phase difference being detected by a distance measurement sensor when irradiation light is emitted at a first frequency, the second phase difference being detected by the distance measurement sensor when the irradiation light is emitted at a second frequency higher than the first frequency, and

determines the number of cycles of 2π from the number-of-cycles determination expression in a case where it is determined that the condition is satisfied and calculates a distance from an object by using the first phase difference and the second phase difference.

(13)

A distance measurement device including:

a distance measurement sensor that detects a first phase difference when irradiation light is emitted at a first frequency and detects a second phase difference when the irradiation light is emitted at a second frequency higher than the first frequency; and

a signal processing device that calculates a distance from an object by using the first phase difference or the second phase difference, in which

the signal processing device includes
a condition determination unit that determines whether or not a condition that neither carrying nor borrowing occurs is satisfied in a number-of-cycles determination expression for determining the number of cycles of 2π of either the first phase difference or the second phase difference, and
a distance calculation unit that determines the number of cycles of 2π from the number-of-cycles determination expression in a case where it is determined that the condition is satisfied and calculates the distance from the object by using the first phase difference and the second phase difference.

### REFERENCE SIGNS LIST

10 Distance measurement system
11 Light source device
12 Distance measurement device
21 Light emission source
31 Light emission control unit
32 Distance measurement sensor
33 Signal processing unit
41 Image acquisition unit
42 Environment recognition unit
43 Condition determination unit
44 Drive parameter setting unit
45 Image storage unit
46 Distance calculation unit
201 Smartphone
202 Distance measurement module

1. A signal processing device comprising:
a condition determination unit that determines whether or not a condition that neither carrying nor borrowing occurs is satisfied in a number-of-cycles determination expression for determining the number of cycles of 2π of either a first phase difference or a second phase difference, the first phase difference being detected by a distance measurement sensor when irradiation light is emitted at a first frequency, the second phase difference being detected by the distance measurement sensor when the irradiation light is emitted at a second frequency higher than the first frequency; and
a distance calculation unit that determines the number of cycles of 2π from the number-of-cycles determination expression in a case where it is determined that the condition is satisfied and calculates a distance from an object by using the first phase difference and the second phase difference.

2. The signal processing device according to claim 1, further comprising
a drive parameter setting unit that changes drive parameters of the distance measurement sensor and a light emission source that emits the irradiation light in a case where it is determined that the condition is not satisfied.

3. The signal processing device according to claim 2, wherein
the drive parameter setting unit changes the drive parameters so as to increase an amount of light emission of the irradiation light having the first frequency.

4. The signal processing device according to claim 2, wherein
the drive parameter setting unit changes the drive parameters of the distance measurement sensor and the light emission source that emits the irradiation light also in a case where it is determined that the condition is satisfied.

5. The signal processing device according to claim 4, wherein
in a case where it is determined that the condition is satisfied, the drive parameter setting unit changes the drive parameters so as to reduce an amount of light emission of the irradiation light having the second frequency.

6. The signal processing device according to claim 1, wherein
in a case where it is determined that the condition is satisfied, the distance calculation unit determines the number of cycles of 2π from the number-of-cycles determination expression and generates a depth map by using the first phase difference and the second phase difference.

7. The signal processing device according to claim 1, wherein
in a case where it is determined that the condition is satisfied, the distance calculation unit synthesizes a first depth map of the first frequency and a second depth map of the second frequency and generates a depth map having an expanded dynamic range.

8. The signal processing device according to claim 1, wherein
the condition determination unit calculates an evaluation value for determining an influence of ambient light and determines a combination of the first frequency and the second frequency on a basis of the evaluation value.

9. The signal processing device according to claim 8, wherein
in a case where the evaluation value is equal to or larger than a predetermined threshold, the condition determination unit determines the combination of the first frequency and the second frequency to be changed to increase an effective distance.

10. The signal processing device according to claim 8, wherein
in a case where the evaluation value is equal to or larger than a predetermined threshold, the condition determination unit determines the combination of the first frequency and the second frequency such that at least one of the first frequency or the second frequency becomes larger than before.

11. The signal processing device according to claim 1, wherein
the condition determination unit determines whether or not the condition is satisfied in the number-of-cycles determination expression also by using a third frequency different from the first frequency or the second frequency, and
the distance calculation unit calculates the distance from the object also by using a third phase difference detected by the distance measurement sensor when the irradiation light is emitted at the third frequency.

12. A signal processing method, wherein
a signal processing device
determines whether or not a condition that neither carrying nor borrowing occurs is satisfied in a number-of-cycles determination expression for determining the number of cycles of 2π of either a first phase difference or a second phase difference, the first phase difference being detected by a distance measurement sensor when irradiation light is emitted at a first frequency, the second phase difference being detected by the distance measurement sensor when the irradiation light is emitted at a second frequency higher than the first frequency, and
determines the number of cycles of 2π from the number-of-cycles determination expression in a case where it is determined that the condition is satisfied and calculates a distance from an object by using the first phase difference and the second phase difference.

13. A distance measurement device comprising:
a distance measurement sensor that detects a first phase difference when irradiation light is emitted at a first frequency and detects a second phase difference when the irradiation light is emitted at a second frequency higher than the first frequency; and
a signal processing device that calculates a distance from an object by using the first phase difference or the second phase difference, wherein
the signal processing device includes
a condition determination unit that determines whether or not a condition that neither carrying nor borrowing occurs is satisfied in a number-of-cycles determination expression for determining the number of cycles of 2π of either the first phase difference or the second phase difference, and
a distance calculation unit that determines the number of cycles of 2π from the number-of-cycles determination expression in a case where it is determined that the condition is satisfied and calculates the distance from the object by using the first phase difference and the second phase difference.
